(19) United States
(12) Patent Application Publication
(10) Pub. No.: US 2003/0147369 A1
(43) Pub. Date: Aug. 7, 2003

(54) Secure wireless transfer of data between different computing devices

(76) Inventors: Ram Naresh Singh, Fremont, CA (US); Srinivasu Pappula, Folsom, CA (US); Arjun Jayaram, Fremont, CA (US)

Correspondence Address: J. NICHOLAS GROSS, ATTORNEY AT LAW, 726 DUBOCE AVE., SAN FRANCISCO, CA, 94117, US

(21) Appl. No.: 10/327,775

(22) Filed: Dec. 24, 2002

Related U.S. Application Data
(60) Provisional application No. 60/344,727, filed on Dec. 24, 2001.

(51) Int. Cl. H04Q 7/24

(52) U.S. Cl. 370/338; 370/353

(57) ABSTRACT

The present invention provides a system and method for transmitting data securely over a wireless network between two different computing devices. The deficiencies of limited wireless bandwidth and frequent connection “breaks” in the wireless network are overcome through intelligent packetization schemes.

### CROSS REFERENCE TO RELATED APPLICATIONS

This application claims the benefit of U.S. Provisional No. 60/344,727 filed Dec. 24, 2001, and which is incorporated by reference herein.

### FIELD OF THE INVENTION

The present invention relates to secure wireless transfer of data between different computing devices.

### BACKGROUND OF THE INVENTION

The tremendous advances in the computing and communications industries have brought an enormous amount of power into the hands of the user. The “anytime, anywhere” access to information is slowly becoming a reality. The popularity and affordability of wireless enabled devices have made these devices more prevalent. The increase in device memory and computational power is leading to more powerful enterprise applications being made available for these devices. These applications now have data that resides locally on these devices.

In general, secure wireless data transfer brings together several important functions: wireless data and its preparation for transfer, wireless data service and security (encryption and authentication). All of these functions must be implemented in an efficient, consistent, and unified fashion that is appropriate for a particular application and wireless network However, it is extremely difficult to achieve such goals while preserve ease of use for the end user.

For example, it is a challenge to install a mobile application onto a portable device in an easy, seamless fashion. The prevalent way of installing a wireless application to a device is by downloading the application to a personal computer and then requiring the user to perform a manual “hot sync” operation. This is contrary to the “anytime, anywhere” promise of a wireless device as the user still needs to go to a wired personal computer. Attempts to download a complete application wirelessly have been hampered by the bottleneck of low wireless bandwidth and a wireless connection, which is prone to disruptions, or transmission “breaks”.

Thus, the current solutions are not flexible, reliable or scalable for installing mission critical applications onto mobile devices. Furthermore, once installed, many software applications require upgrades and patches on a frequent basis. For example, a new virus patch may be needed for a mobile virus scan application. Currently, there is no reliable wireless solution that addresses the seamless install and upgrade issues.

Enterprises are also facing the problem of supporting different types of devices within a unified IT framework. The complex problems associated with the asset management and systems management of these assets has driven up the Total Cost of Operation (TCO) of these devices. There is no solution available today that effectively addresses the needs of the enterprise in solving these systems management issues.

A need therefore, exists for a software architecture, data model, access protocol and an Application Programmer Interface for devices that require wireless data transfer. These have to be designed to work in low bandwidth, occasionally connected, frequently disrupted channel environments and relatively low computational power of mobile devices. Furthermore, for a system that includes these components (wireless data transfer, wireless installs, alert propagation and asset management) to be useful and applicable, an Application Programmer Interface will be needed for third party application developers to use the underlying framework to move proprietary wireless data.

The current solutions attempt to deliver a complete application through a narrow wireless bandwidth channel is to use the same technique as that used in a broadband channel. The ‘packetization’ is done at the protocol level. The protocols are designed to have the complete data transfer as a single transaction. Accordingly, the state of the completeness of the data transfer is not updated while the operation is in progress. This means that if the data transfer has to resume because of a broken wireless connection, the operation must restart from the beginning. Advanced TCP/IP programming will eventually allow users to set a packet size for a transport. But this will not solve the problem in its entirety, however, since communication bandwidth is extremely varied in a mobile environment. It would be preferable to have a more flexible and adaptive way to dynamically configure the packet size for data transport. Furthermore, it would be useful to consider the bandwidth, the available free memory, the processing power on the portable device, and the battery life when configuring a data transport session.

Alerts are another feature commonly implemented in wireless environments. The current approach to alert propagation uses an extension of the industry standard SMS protocol. A set of rules and a set of recipients are saved in a database. When certain error conditions are satisfied, an SMS message is sent to the recipients. The recipients are sent text messages but no data when an alarm is sent to them. They then have to log in to their respective systems using a laptop, a desktop or a WAP phone to get access to the data. It would be desirable to have additional functionality for alerts, including the ability to add messages, data and actions with an alert. Furthermore, the footprint on the portable device should be in a position to interpret the message and actions, and use the data locally on the device for easier diagnostics by the recipient.

### SUMMARY OF THE INVENTION

The objects of the present invention, therefore, are to address the aforementioned limitations in the prior art, and to provide additional embodiments of scalable and customizable wireless systems, data transport systems, packet protocols, wireless application installation systems, wireless alert systems, application program interfaces, wireless Internet application servers, mobile computing client devices, and methods of operating such systems and devices.

Other objects of the present invention, therefore, are to provide a secure and efficient way for transferring wireless data of any kind between different types of computing devices while overcoming the deficiencies of limited bandwidth and connection “breaks” in wireless channel environments.

These and other objects are accomplished by various embodiments of the present invention as described in detail below, it being understood by those skilled in the art that many embodiments of the invention will not use or require all aspects of the invention as described herein.

As will be seen herein, the invention allows for a simpler, more secure and faster way for transferring date between disparate devices than previously available. The wireless data could be applications, images, phone books and memos/tasks—in short, anything that can be resident on a wireless device.

### BRIEF DESCRIPTION OF THE DRAWINGS

FIG. 1 is a block diagram illustrating the basic components of an overall architecture of a wireless data system configured in accordance with a preferred embodiment of the present invention.

FIG. 2 is a block diagram illustrating the basic components of a server side system and handshake processing system configured in accordance with a preferred embodiment of the present invention.

FIG. 3 is a block diagram illustrating the basic components of a mobile computing device configured in accordance with a preferred embodiment of the present invention.

FIG. 4 is a flow chart showing the steps involved in device side handling of wireless installs and alarms in accordance with the preferred embodiment of the present invention.

FIG. 5 is a flow chart illustrating the basic functions performed by a smart packetization module configured in accordance with a preferred embodiment of the present invention.

FIG. 6 is a flow chart illustrating the basic functions performed by a smart download module configured in accordance with a preferred embodiment of the present invention.

FIG. 7 is a block diagram illustrating the basic components of an asset management system used for tracking devices on a server configured in accordance with a preferred embodiment of the present invention.

FIG. 8 is a flow diagram illustrating the manner in which client devices are detected by a server and tracked configured in accordance with a preferred embodiment of the present invention.

FIG. 9 is a flow chart showing the steps involved for data encryption in the smart packetization module configured in accordance with a preferred embodiment of the present invention.

FIG. 10 is a flow chart showing the preferred steps involved for determining an optimum packet size at run time configured in accordance with a preferred embodiment of the present invention.

FIGS. 11a and 11b are flow diagrams illustrating the basic functions performed by a Server Alarm Manager system configured in accordance with a preferred embodiment of the present invention.

FIG. 12 is a flow chart showing the preferred steps involved in a communication module configured in accordance with a preferred embodiment of the present invention.

FIG. 13 is a flow chart showing the steps involved for wireless installation of an application on a mobile device in accordance with a preferred embodiment of the present invention.

FIGS. 14a, 14b and 14c provide details on command types used in a command module in accordance with a preferred embodiment of the present invention.

FIG. 15 depicts various building block components used for client device state information in accordance with a preferred embodiment of the present invention.

FIGS. 16a-16d show elements of a GUI handler and its interaction with the command module using scripting configured in accordance with a preferred embodiment of the present invention.

FIG. 17 is a flow chart showing the preferred steps performed by a packer decoder module configured in accordance with a preferred embodiment of the present invention.

FIG. 18 shows a format of a sample unencrypted data packet configured in accordance with a preferred embodiment of the present invention.

FIG. 19 shows the basic components of a data packet configured in accordance with a preferred embodiment of the present invention.

FIG. 20 shows the various steps performed for a data upload in accordance with a preferred embodiment of the present invention.

FIG. 21 is a flow chart showing the preferred steps performed by a decryption module configured in accordance with a preferred embodiment of the present invention.

FIG. 22 shows the basic components of the high availability module configured in accordance with a preferred embodiment of the present invention.

### DETAILED DESCRIPTION OF THE PREFERRED EMBODIMENT

Introduction

The present invention has several key components, discussed in detail below. A short introduction follows to explain certain basic features and operations of the wireless installation and alert systems disclosed herein.

Wireless Installs

The present invention reduces and/or eliminates the need for users of mobile devices to download an application (or game) to their personal computer and then “hot sync” the application (or game) to their mobile device. A client device performs an initial handshake with a server. The server detects the type of client device that initiated the handshake. The client device also provides information regarding its “state”. An algorithm on the server side determines a preferred packet size to be used when transferring the data to the client device.

The other part of this system is certain server side intelligence, which determines the type of applications to be installed on the client device based on the device type, free memory and available battery life to complete a download and install based on available bandwidth. After determining this information, the server sends a list of applications for the user to select and install. The server side algorithm ensures that the list presented to the user doesn't contain applications that have already been installed on the device. The device displays this list on the device screen and the user can select an application to install.

The client device then sends a request to get the application downloaded onto the device. The server processes this request and sends data in a customized packet format, which contains among several meta data information, the current packet number and the total number of packets. The data is encrypted using any standard encryption mechanism.

As mentioned earlier, the size of the data packet is determined to maximize the available bandwidth. If a data packet is received in an incorrect order, or if a packet gets corrupted in transit, the device can detect it and request the packet again. When all relevant packets are received on the device, they are decrypted and reassembled.

A packet header contains information about the type of encryption that was performed on the data before transferring it to the device. It also contains a module name to be invoked on the device for decrypting the data. The application is then installed locally on the device.

Wireless Alerts Propagation

There are many cases when a mobile user may need to be alerted the first time he/she is logged into a system. The alerts can be simple messages like “contact X at time Y” or anti-virus downloads or software upgrades. All these alerts are “pushed” to the device. An instruction set is also sent, indicating which actions need to be performed on the device upon receipt of the data and alerts. The device gets the data and executes the instruction set sequentially.

A short glossary is provided to assist in understanding the discussion below:

TCO—Total Cost of Operation

IT—Information Technology

ASPs—Application Service Providers

HTML—Hyper Text Markup Language

JSP—Java Server Pages

FTP—File Transfer Protocol

EJB—Enterprise Java Beans

ODBC—Open Database Connectivity

CRM—Customer Relationship Management

HTTP—Hyper Text Transfer Protocol

GUI—Graphical User Interface

TCP/IP—Transmission Control Protocol/Internet Protocol

Overall Structure of Wireless Data Communication System

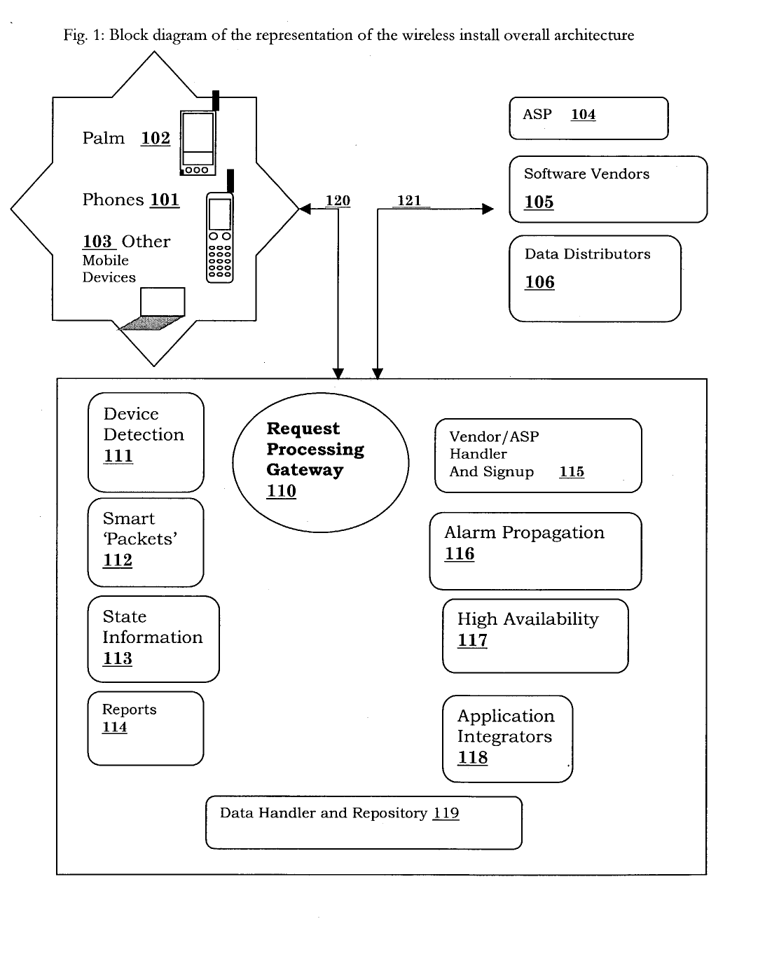

A block diagram of the hardware elements used in a preferred wireless data communications system 100 of the present system (including more detailed features of a server side system 109) is shown in FIG. 1. It will be understood by those skilled in the art that some non-material aspects of the system shown in FIG. 1 have been simplified and/or omitted in order to better explain the scope of the present invention. Furthermore, while aspects of the present invention are explained by reference to such preferred embodiment and other specific architectural implementation details, the scope of the present invention is by no means limited to any embodiments and details discussed herein, and many other variations, additions, modifications, etc. will be apparent to those skilled in the art from the present disclosure.

As seen in FIG. 1, a wireless system 100 includes generally three primary components. The first component is a set of client devices used by users of (or subscribers to) a wireless communications system, such as a Palm Pilot 101, a Cell Phone 102, and/or other mobile device 103 such as EPOC, Blackberry and the like, which communicate through a wireless service provider channel link 120 to the Internet. Hereafter, the term “client device” is intended to denote one or more or such devices. Furthermore, these are but examples of wireless communication devices, and it will be understood by those skilled in the art that a number of different devices can be used in the present system as a client device.

These devices therefore connect to a second component, which can be referred to as a Server 109, through a Request Processing Gateway 110. Request Processing Gateway 110 acts as a secure access point from the outside world into a service network (not shown) storing data and applications accessible to subscribers/users of the same. Such data and applications can be made available within Server 109 to be exported through Request Processing Gateway 110. In a preferred embodiment, it is envisioned that the server 109 will be part of a larger system of servers and storage maintained by a Wireless Service Provider supporting a large enterprise network as may be used by a large corporation. The enterprise network contains storage and applications, which facilitate communications between employees, customers, vendors, etc., and tools for cooperating on projects electronically.

The third component of system 100 includes certain ASPs, Software Vendors, Data distributor systems etc as shown by blocks 104, 105 and 106 and which host data that can be transferred through other channel links 121 to Server 109. Preferably such channel links 121 are able to communicate using standard HTTP protocol and a standard web interface. These facilities are able to upload their application programs and data through the Request Processing Gateway 110 (or some other entry point to a service network) to Server 109 for the service network (or other servers hosted by Wireless Service Providers) so that it can be distributed as wireless data to wireless users. Again, blocks 104, 105 and 106 merely depict exemplary facilities for uploading data to server 109, and it is understood that other platforms, providers, etc., can be used for such purpose.

As an example, a games developer can log on to system 100 if they are registered users of the system, upload a game to Server 109 and make the games available for download to all users who access the system. This is done in a seamless manner within a secure data transmission framework that the present invention provides. The typical bandwidth problems are overcome here by the smart packetization feature of block 112, which creates packets of data after talking into account the available bandwidth for transmission. This ensures that the data packets are sized to allow for the most efficient means of transmission.

Client—Server Handshaking Process

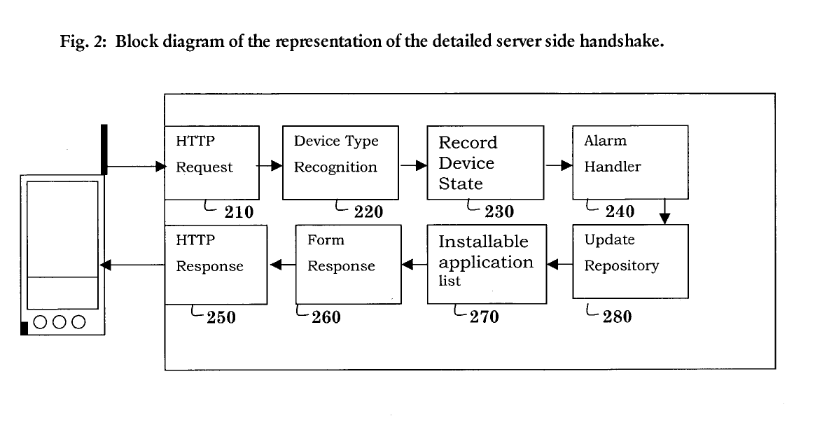

FIG. 2 shows the sequence of steps that are performed on server 109 by a series of server handshake modules following a request for data from a client device. As used herein, server 109 generally refers to a combination of a software application running on a hardware-computing server, hosting one or more wireless applications. In a preferred embodiment, server 109 is a Pentium class or Unix equivalent server with 256 MB or more RAM, Windows NT, Linux, Solaris or other Java 1.2 enabled operating system. It will be understood, of course, that a variety of conventional server systems will be suitable for the present invention, and the latter is not limited in such respect.

The software running on server 109 includes a combination of software routines or modules configured for facilitating a handshake with a client device. The handshaking functions performed by these modules include generally the following:

An HTTP Request (Block 210) module handles requests received by server 109 from the client device. The request is basically handled as a servlet level interaction between the device and the server. The client devices communicate to server 109 using standard HTTP get and post commands. The HTTP request servlet on server 109 gets the parameters that are passed in the get and post commands. These parameters contain information on the client device type, the client device state etc.

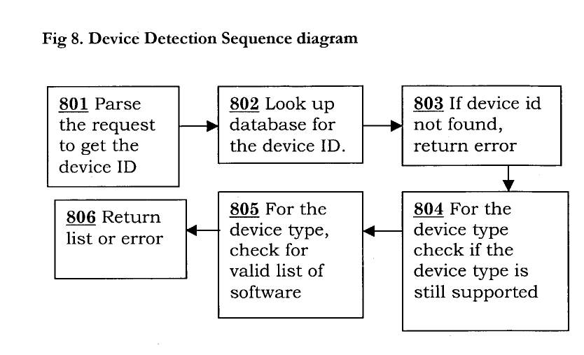

Device Type Recognition (Block 220) module is responsible for determining the type of client device that has made a data request. HTTP request module 210 invokes this module. A device ID is passed as a parameter. Module 220 performs a database lookup to determine which device from the list of supported devices from the data repository has made the request. The database (not shown) contains information on the type of device that is associated with a specific ID. If the device type is supported, the appropriate device type is returned; else the device type is returned along with an error state that the device is no longer supported. The database can be implemented in any conventional fashion, and is not material to the present teachings. Further details on the nature and operation of module 220 are provided below in connection with the discussion for Device Detection module 111 explained in FIG. 8.

Record Device State (Block 230) Referring to FIG. 2 again, the HTTP request contains information on the state of the client device as well. The Record Device state module 230 is invoked bypassing these parameters. The device state information, including such parameters as available storage, available memory, available stack space, processor type, bandwidth capabilities, etc., and is useful in making the following important determinations:

Applications that can be downloaded to the device based on the free memory

The packet size depending on the amount of bandwidth and free stack space

The type of encryption depending on the type of processor on the device

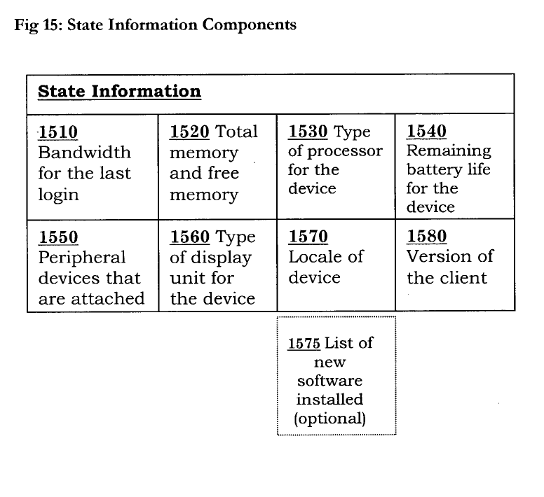

It will be appreciated, of course, that this is merely exemplary device state data, and other information could be provided on an as-needed or as-desired basis. Furthermore, it will be understood by those skilled in the art that the type and amount of device state information used in any implementation will vary on a device by device basis, and could even vary on a user-by-user basis to differentiate service types. The device state information is preferably saved in a device state record in a data repository (not shown) for each unique client device that is connected to server 109. Further details on the Record Device State module 230 is discussed below in connection with FIG. 15.

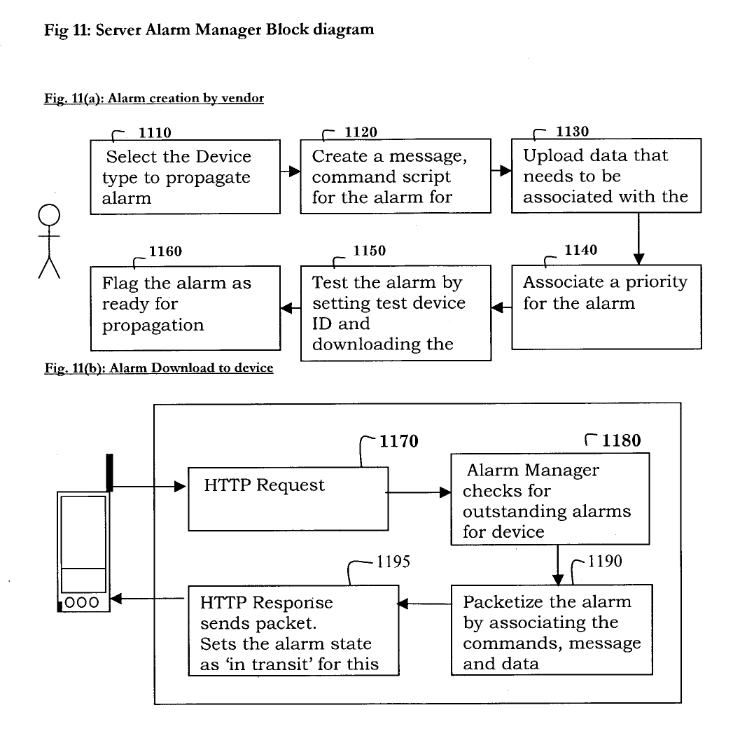

Alarm Handler (Block 240) in FIG. 2 is a module that determines if any alarms need to be propagated to one or more client devices. The alarms can be defined or differentiated according to broad categories: i.e., a broadcast type alarm intended for all devices of a particular type, or for all users of a particular application, or they can be defined and generated as targeted alarms for a specific device (or user). All generated alarms are placed into an alarm queue. The alarms are preferably sent as packets to the device. In some instances, however, it is conceivable that alarms could be sent outside the normal communications link to enhance their propagation and/or improve the likelihood of their reception. Further details on the Alarm Module 240 are discussed below in connection with FIG. 11.

Update Repository (Block 280) module in FIG. 2 is responsible for updating the data repository discussed above with the following information:

State information of the device

Information of the last login for the device

Information on the alarms that have been propagated to the device

Installable Application List (Block 270) module is responsible for determining and building an available/suitable list of applications that are relevant for a particular device. This is determined, in part at least, by some of the device state information that is saved into the data repository. This module analyzes application requirements, and makes a comparison with the minimum hardware requirements of the applications to determine whether an appropriate ‘fit’ is available between any particular application and any particular device.

Form Response, HTTP Response (Blocks 260, 270) modules create appropriate responses and transmit them back to the device in response to the data request. The response can contain alarm information, a list of all the applications as noted earlier, and qualifiers for each application. The qualifiers contain information on the size of the application, a packet size, and a total number of packets etc., required for transmitting the application. This response is then converted into an HTTP response sent to the device.

The above of course is merely an example of a preferred handshaking process that could be used in an embodiment of the present invention, and that variations on the above are clearly suitable for many applications. Other embodiments of the handshaking process modules could perform additional functions in addition to those identified above. Furthermore, in the interests of better explaining the details of the handshaking process, many conventional implementation-specific details well-known to those skilled in the art have been omitted, but could be incorporated in embodiments of the present invention. For example, other types of information could be exchanged between a client and server based on system performance requirements, subscriber status, service requirements, system status, etc.

Finally, while the functions and features described above for the server side modules are unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such modules as described herein.

Device Detection

Returning to FIG. 1, the Device Detection module 111 shown there is responsible for the detection of the type of device that initiated a request. As noted above, the handshake process contains information that can uniquely identify the device ID and device type. There is also additional information regarding the state of the device that can be passed as a part of the initial handshake. The Device Detection module 111 performs a repository look up to identify the device records. It also updates the Device State and the time of the last login from the device.

For example, a mobile user that has signed up to receive wireless transfer from server 109 could send a request with an ID 10H919D0CJKU (the hardware vendor provided ID for the device). This unique Id can be mapped to a Palm VII user. The system then tailors its responses for a Palm VII target device.

The Device Detection module 111 is invoked in response to a HTTP request from server 109. FIG. 8 shows the general sequence of steps performed by such module. In brief, a database look up is performed to see if a matching device ID can be located. A missing device ID implies an unsupported device. In that case, the module returns an error.

Step 801 Device Detection module 111 is invoked. The HTTP request header from the device is passed as a parameter. The module parses this information to get the id of the device that issued the HTTP request to server 109. The module then requests a connection from a connection pool to perform a device ID database (not shown) lookup.

Step 802 If the device ID is found in the device ID database, the device type information can be obtained from the database. The module then performs an additional database look up to check for a valid list of software for the device. Information from the rows that are retrieved from the database is transformed into a string array.

Step 803 If the device ID is not found, it is probably an invalid user or a user account in delinquency. If so, an error and an appropriate error message is returned.

Step 804 If the device ID is valid, the type of the device is obtained from the database. It is also checked to determine if server 109 still supports devices of that type. For example, a Wireless service provider may stop supporting certain types of devices like those with the EPOC operating system. In that case, an appropriate error code and error message is returned.

Step 805 A list of software that can be installed on the system is then checked as well. This determination is based on certain set of conditions that are imposed by the vendors of the application, the details of the application, and the state characteristics of the device. For instance, if all available software on server 109 available for that type of device has already been downloaded to a particular mobile device, an empty list is returned. On the other hand, if there is software that can be downloaded, a check is made against the necessary state conditions for each of the software. If the device meets the minimum state requirements, the software is added to the list of software available for download to the device.

Step 806 The list that is created from Step 805 is returned to the device.

In order to handle multiple requests, Enterprise Java Beans are preferably used at server 109 to store the information for each client device. Each of the client devices that are supported is encapsulated into an entity bean. There is a separate entity bean for a different device, for e.g.: Palm VII, Palm m505 and BlackBerry. An entity bean is also created for each of the device type that runs EPOC, WinCE etc. The entity bean caches some of the information so that redundant lookups to the database can be avoided to improve the performance of the system.

The above of course is merely an example of a preferred device detection process that could be used in an embodiment of the present invention, and that variations on the above are clearly suitable for many applications. Other embodiments of Device Detection module 111 could perform additional functions in addition to those identified above. Furthermore, in the interests of better explaining the details of the device detection process, many conventional implementation-specific details well-known to those skilled in the art have been omitted, but could be incorporated in embodiments of the present invention. For example, the device ID could take a variety of forms, and be generated, determined and checked using a variety of techniques. The device ID could be fixed, or dynamically generated for a particular device, session, etc. and may implicitly carry with it data specifying a usable lifetime for such device. For example, certain types of portable phones may be configured as disposable products having a finite lifetime. Wile Java Beans are used in the preferred embodiment, the device state information can be stored in any convenient fashion suitable for a particular computing platform. In non-Java based systems for example, other types of caching mechanisms will be used.

Finally, while the functions and features described above for the device detection modules are unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such modules as described herein.

Data Upload

Returning to FIG. 1 again, the Vendor/ASP Handler And Signup module 115 performs a number of functions, including authenticating the Vendors and the administrators from the ASPs. New vendors can sign up using an HTML and JSP forms that service the appropriate servlets to create new vendors. This module allows vendors 105 and other parties (ASP 104 and Data Distributors 106) to upload new applications to server 109 for wireless transfer to specific types of devices. Server 109 can be configured with any conventional web interface for allowing such current data distributors to upload the data and make it available for distribution. Again, it will be understood that there may be a variety of entry points for disseminating such data to server 109, and that the data maybe uploaded in a variety of forms with/without using an Internet link, including in distributable media, through a private network etc.

Moreover, in some instances, the uploaded data may come directly from another subscriber of the system, such as from a personal computer, or another mobile device. In some implementations, a form of wireless peer-to-peer data transfer may be made available for exchanging data directly between subscribers.

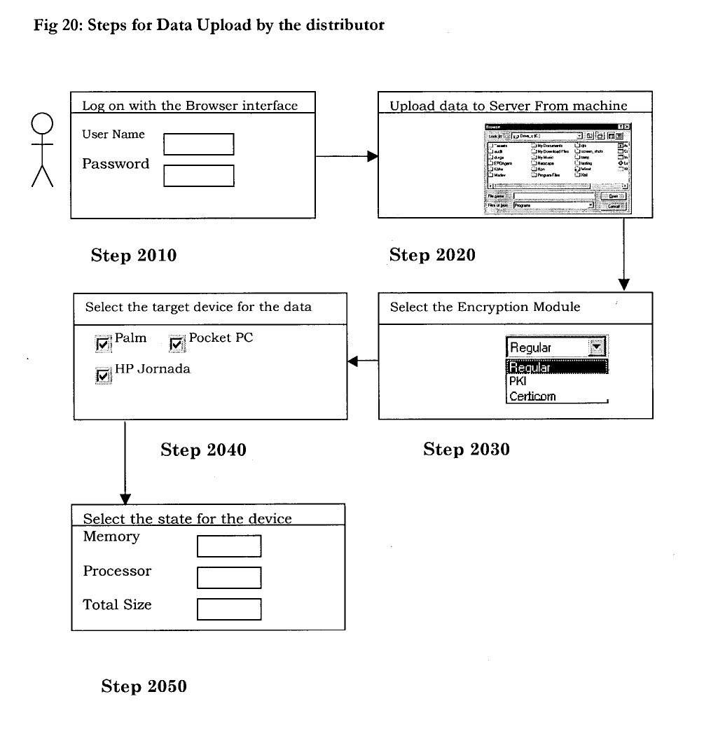

FIG. 20 shows the general steps used for uploading data by distributors and other third parties.

Step 2010, Step 2020 After successfully logging into server 109 through a web interface, the vendor of a software application (or a distributor of wireless data) uploads the appropriate data to server 109 used by a wireless service provider(s). This is done preferably using a standard HTTP file upload protocol. In other instances, premium users can be allowed secure FTP accesses to server 109. Other forms of differentiated access rights can be used as well to optimize resources.

Step 2030 After uploading the data to server 109, a data distributor (optionally) selects an encryption module. The default encryption is base 64. If the application is highly sensitive, a user can request for a higher base for the encryption. The distributors/vendors can also view a list of third party applications for the encryption. Again, in some instances encryption may not be needed or desired. Other forms of file identification/protection known in the art can be specified at this time as well, including watermarking, steganography, etc.

Step 2040 The distributors/vendors select the target device type for the application deployment. For e.g.: the vendor would be able to specify through a web interface that the application is suited for a Palm operating system or a WinCE operating system. Other types of devices can be supported as well, and will vary from provider to provider.

Step 2050 The distributor/vendor specifies the desired hardware, memory and display settings requirements for the target devices for deploying the application. This would be used as part of the necessary conditions used to determine if a device passes the criteria for installing an application. Of course other types of hardware criteria can be specified in addition to or in lieu of those specified in FIG. 20, and such is not intended to be an exhaustive list.

The above of course is merely an example of a preferred upload process that could be used in an embodiment of the present invention, and that variations on the above are clearly suitable for many applications. Other embodiments of an upload process could perform additional functions in addition to those identified above. Furthermore, in the interests of better explaining the details of the upload process, many conventional implementation-specific details well-known to those skilled in the art have been omitted, but could be incorporated in embodiments of the present invention.

The web interface for the data uploads could take a variety of forms, and be generated using HTML, Java and similar web based form tools. A customized interface could be provided in many cases to accommodate particular favored distributors/vendors, or for distributors having particular application needs that vary from those indicated above.

Other types of criteria could be specified for a device, or for an application, as conditions to be met before allowing an application to be downloaded to a particular subscriber. For example, in addition to technical criteria, other restrictions, such as geographic factors might be employed to control distributions of software, so that certain types of software/data could be prevented from dissemination in certain markets. Alternatively a distributor may control access to an application to only certain subscribers satisfying certain subscriber status criteria defined by the distributor and/or the wireless service provider. Other marketing, demographic and similar factors can be used in setting distribution criteria.

Finally, while the functions and features described above for the uploading module are unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

Smart Packetization

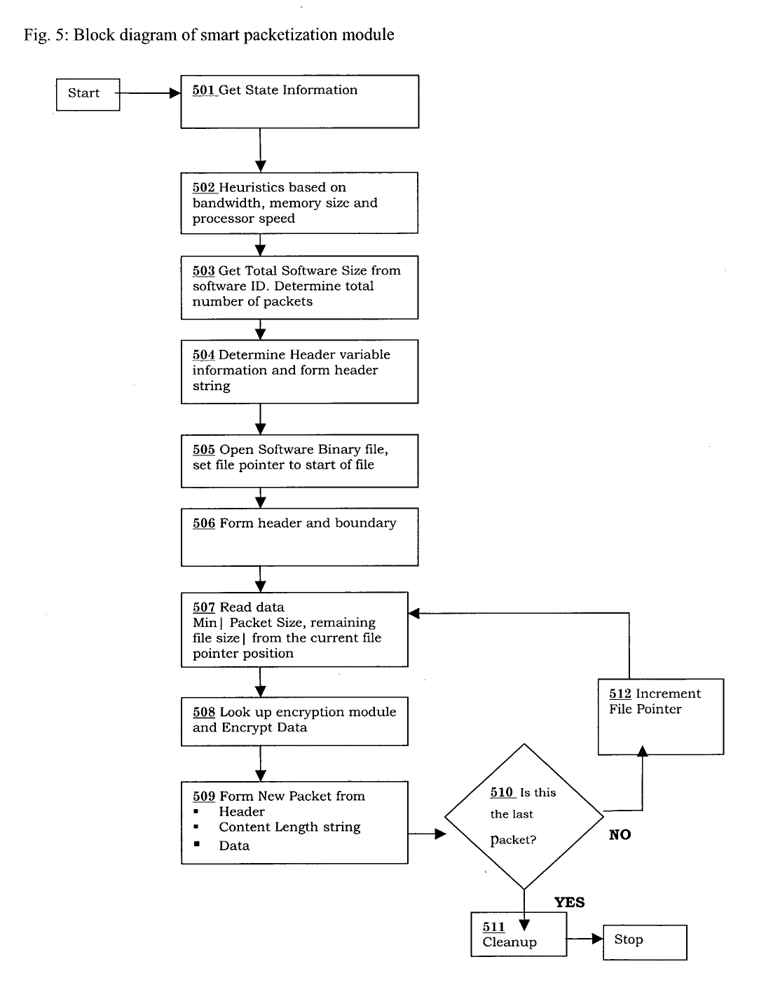

Again referring to FIG. 1, the Smart Packets Module 112 is responsible for creating packets of data, in this instance, preferably as an “on demand” process. The details of how such module operates are set out in FIG. 5, including an identification of the different sub processes and decision modules used in the Smart Packet module 112.

As seen in FIG. 5, at step 501 the State Information module 113 (FIG. 1) is invoked at this stage. As noted earlier, this module provides information on the total memory of the device, the free memory, the processor speed, the remaining battery life and the peripheral devices that are attached to the device. This is passed to the server during the initial HTTP noted earlier request. According to the present invention, a size of the packets and a type of encryption to be used are determined independently during each data communication session by the state of the device that requests such data.

The overall packetization process is depicted generally in FIG. 5. This includes the following steps:

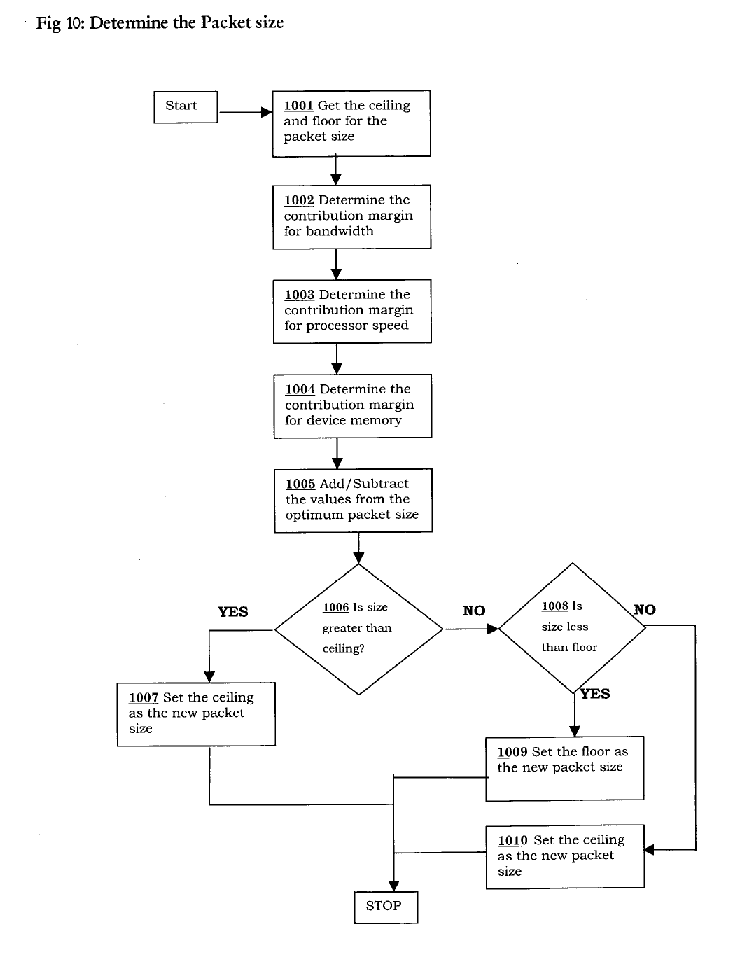

Step 502: A heuristic algorithm is invoked to determine an appropriate and/or optimal packet size is invoked. This algorithm is discussed in more detail below (see FIG. 10).

Step 503: A total size of the data that has been requested for download is determined using any conventional technique. Given the appropriate/optimal packet size, the number of packets for the data is then determined as well. Furthermore, to the extent any additional overhead data is required as part of the data session to transmit the data to the client device (i.e., for example, if certain control information must be sent to the device, or if an alarm must be sent as well) this is also factored in at this time.

Step 504: A header information string is formed at this point. The variables for the header information are available at this point. The information is truncated to form a string variable dynamically and the length of the string is computed. This forms a header length.

Step 505: The information from a particular file (data, application, etc.) or files is read for the purpose of creating data packets. The file needs to be opened and the file pointer set to the beginning of the file. While a binary file is preferably used, any electronic form can be used with embodiments of the present invention. A new temporary packet file is also created in a temporary location. The temporary file is used to hold the packet contents, which will be added dynamically.

Step 506: The header and boundary information are now written into the temporary packet file. The boundary information forms the demarcation line between two packets and is parsed to identify the start of a new packet.

Step 507: While there is more data to be read from the file and converted to packets, steps 507 to 510 are performed as a loop, or in an iterative fashion. Thus, the data is read from the input file. The resulting encrypted data (i.e., after an encryption operation) should not exceed the recommended/optimal packet size. If the encryption process is known to create a percentage reduction or increase in the size of the data, this can be factored into the determination of a suitable packet size, and the total size of the data file.

Step 508: The data is encrypted, or an already encrypted file is used (if such exists for a particular application for example). A look up is made to the database to determine the appropriate encryption algorithm to be used. If the user wishes to use custom encryption, such module is invoked. The header for the packet is written or modified to identify the type of encryption and the corresponding module used for the same.

Step 509: A check is made to determine if the last packet is being formed. If yes, the data file is closed, and the database is updated to log the packetization process for this file as a logged activity for such user.

Step 510: The file pointer is incremented by the size of the data that was read in step 507 in the current iteration. A return is made to Step 507 after incrementing the file pointer at step 512 when the packet being formed is not the last packet for the data transmission.

Step 511: If the last packet has been processed, a cleanup operation is done where the memory locations used for creating temporary files are freed up.

The above of course is merely an example of a preferred packetization process that could be used in an embodiment of the present invention, and that variations on the above are clearly suitable for many applications. Other embodiments of an packetization process could perform additional functions in addition to those identified above. Furthermore, in the interests of better explaining the details of such process, many conventional implementation-specific details well-known to those skilled in the art have been omitted, but could be incorporated in embodiments of the present invention.

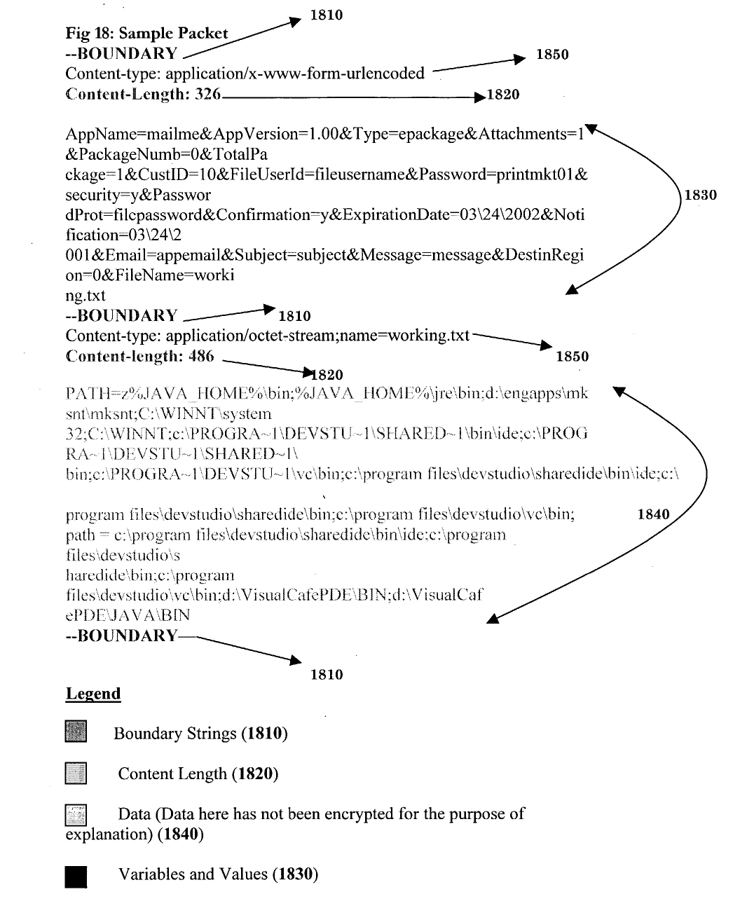

FIG. 18 shows a format for a sample packet 1800, including some of the key various components thereof. It will be understood of course that not all pertinent parameters that could be used are shown in such sample packet. As seen in FIG. 18, 1810 refers to the boundary of packet 1800. 1820 is a field identifying the content length and field 1830 refers to any and all variables and values contained in packet 1800. The content type of packet 1800 is indicated by field 1850. Field 1840 contains the data content which is transported by the particular packet 1800. Again, this is intended to be a general representation of the data packet contents, and is expected that the final form and fields used in a commercial application will be a function of particular system requirements and subscriber desires, system constraints, etc.

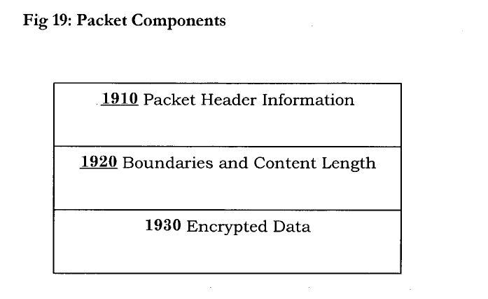

As can be seen in FIG. 18, and in simplified form in FIG. 19, the data packets of the present invention have three major components.

Packet Header information (1910)

Boundaries and content length (1920)

Encrypted Data (1930)

Again, these data packets are formed by a Smart Packetization module 112 when server 109 has to transfer data to subscriber devices (and/or other wireless receivers). To better illustrate the operation of such module, a detailed explanation of how such components are constructed is now provided with reference to FIG. 19.

Packet Header 1910: The packet header contains information that preferably mimics an HTTP packet header. The header also contains any custom application specific information to be ‘coded in’ to the header information. This information is useful, for example, in identifying the particular packet at the device side. The information that is coded into the header is configurable; however there are some key fields which preferably are provided in all packets. They are shown and described briefly in the packet header field table below.

| | Description - Interpretation of variable on the |
|---|---|
| Variable Name | receiving end |
| Packet ID | The identity of the current packet. |
| Software ID | This is the identity of the software (or data). For |
| | example an ID of MSFT_WRD_2000 would indicate |
| | that the software being transferred is Microsoft Word |
| | version 2000. The ID is a unique identity assigned to the |
| | software on the server. |
| Total Number of Packets | This indicates the total number of packets in the current |
| | transmission. |
| Current Packet Number | This is going to be between 1 and the total number of |
| | packets in the current data transportation process. |
| Type and Level of encryption | This indicates the type of encryption used by the |
| used. | transmitter of the data for the packet. |
| Type of packet (Alarm, Message, | This field determines the type of information that is |
| Data etc) | contained in the packet. It could be an alarm, a message, |
| | data etc. |

As will be apparent to those skilled in the art, the particular size, format and content for each packet header field will be a typical design parameter that is a function of a particular implementation, and is not material to the present teachings. The only criterion, of course, is that any such implementation should be suitably adapted to accommodate the functional needs identified for the packet header items described herein. Those skilled in the art will further appreciate that not all fields identified above must be used in every packet or every incarnation of the invention. Thus, a substantial amount of variability may exist between actual commercial embodiments of the invention.

The header can also contain some optional information like the major version number, minor version number, custom application message etc. Other parameters that can be included will be apparent to those skilled in the art based on the present teachings. Again, the header is expected to vary significantly from application to application.

a) Packet ID: The Packet ID field is one key piece of information in the packet header which is preferably included in each header. The packet ID field is preferably a combination of a generated session specific id from the server and a device ID for the device the packet is intended for. In some applications, however, to improve performance, the packet ID may not take the same form for each packet sent during a data session. In the case where a packet size is small, for example, a tradeoff can be made to reduce a packet ID (or overall header size) for some (or even the bulk of) packets during a transmission to improve throughput at the expense of security and/or robustness.

For highly sensitive and secure data packets, a client device can authenticate by means of a double acknowledgement from server 109 if a packet actually originated from such server. For example, if the device ID does not match the actual physical device ID, the packet can be rejected. Other forms of verification can also be used in embodiments of the present invention.

Double acknowledgement is a process by which a device contacts the server again after receiving a packet, and can also be used in embodiments of the present invention. In such case, an HTTP request passes the packet ID of the packet that was just received along with the session ID and packet size. The server sends an authentication back to the device that the server indeed had sent the packet to the device. This ensures that the packet is not modified (hacked) enroute; the device can re-authenticate the packet thereby increasing security in the data transfer. Again, other techniques known in the art can be used as well.

b) Software ID: The Software ID field in packet header 1910 is a variable identifying the software associated with the content being sent. Additional information can also be specified for identifying the vendor and the type of software that will be downloaded based on this ID. Management software on the client device also tracks the different software/data installed on the device from server 109 using such Software ID. This helps in customizing the subsequent software downloads from server 109.

c) Total Number of Packets: This information identifies the total number of packets that are a part of a particular data session, including for a software download and installation. For example, a value of 12 would indicate that there are a total of 12 data packets that are part of the download process.

d) Current Packet Number: This gives the current packet number. Special processing is performed on the device side for the first and the last packets received.

e) Type and Level of encryption used: The present invention gives the flexibility for ‘plugging in’ a custom security package for the purpose of encryption. The encryption type field, therefore, identifies a particular type of encryption used. The default encryption is preferably base 64 encryption, but it can be specified, if desired, on a packet-by-packet basis. The server modules can also be customized to interface with third party algorithms like an encryption algorithm offered by Certicom. The level of encryption field provides additional details for a decryption module on the device side to decrypt the encoded data.

f) Type of Packet: Several types of packets can be sent using the present invention. Thus, this field can be used to specify the type of the packet, such as whether it contains application data, application code, a message, an alert etc.. Other examples will be apparent to those skilled in the art based on the particular environment in which the invention is used. Depending on the type of packet, the information processing on the packet content can be made quite different. For example, the following pseudo code shows the different types of data processing that are possible on the device side depending on the type of packet where:

Boolean bFlagDisplayReq = false;
Switch (pSmartPacketizer- >GetPacketType( ))
{

case MESSAGE:
{

bFlagDisplayReq =

MessageManager (pSmartPacketizer- >GetMessageStructFromPacket ( ));

If (bF1agDisplayReq)

{

GUIManager(DISPLAY_MESSAGE, pSmartPacketizer-

>GetMessageStructFroniPacket ( ));

}

}
break
case ALERT:
{

bFlagDisplayReq = AlertManager (pSmartPacketizer- >GetAlertStructFromPacket ( ));
If (bFlagDisplayReq)

{

GUIManager (DISPLAY_MESSAGE, pSmartPacketizer-

>GetMessageStructFromPacket ( ));
}
}
break;
case DATA:
{
DataManager (pSmartPacketizer- >GetData());
}
break;
default:
{
}
break;
}//end of switch

Boundaries and Content Length 1920. Referring again to FIG. 19, the boundaries separate different sections within a packet. Thus, there are boundaries at the start of a packet, after the header, preceding the data content and immediately following the last data bit. The content length is thus the length of the data between two boundaries. Since the data size is dynamic, a parser at the device first reads the content length and then the complete data content. A check is made to ensure the size of data sent matches the size sent. Thus, receiving software on the device ensures that any data packets that get corrupted in transit are rejected on the device, thereby ensuring the integrity of the data that is transmitted. Additional data verification mechanisms, including conventional parity and checksum processes, can also be used with embodiments of the invention.

Encrypted Data: (1930 in FIG. 19) The data content for each packet is encrypted by an encryption module within the Smart Packetization module 112. This ensures the security of the data that is wirelessly transported using this invention. As noted above, the invention is flexible to allow for custom encryption to be used. Enterprises use highly sophisticated encryption technologies from corporations like Entrust, Certicom, and Verisign etc., or their own customized solutions. Again, a default ‘base 64’ encryption module is preferably used in the present invention. The data repository on server 109 has a configuration module 119 for the install base to specify the type of encryption that needs to used for any particular application. If nothing is specified, it defaults to a base 64 bit encryption.

The Smart Packetization module 112 also determines a number of key packet parameters, including a range of suitable packet sizes, and other factors associated with a session ID, such as available bandwidth. This is done in the following manner:

Determining the Packet Size: The desired size of the packets is determined preferably using a heuristic algorithm. Other techniques can also be used of course. Thresholds are determined, such as a ceiling size and a floor size for the size of the data packets. The packet sizes cannot be greater than the ceiling size and cannot be smaller than the floor size. A reference optimum size for the packets is also determined. However, the reference optimum size is not necessarily used for any particular data transmission; it is merely the case that the packets are preferably sized between the ceiling and floor sizes.

The factors that influence the size of the packets as ultimately used are the following:

Bandwidth

Processor Speed

Battery life and Stack Memory on the device

These are identified above in order of decreasing influence on the size of the packets. It will be apparent, of course, that other factors can be used to determine an optimum packet size, including data traffic conditions in a communications link and other transmission characteristics of such link. Other examples will be apparent to skilled artisans based on the present teachings and known optimization techniques.

A separate hash table is maintained for the different ranges of possible transmission speed values. As an example, for bandwidth the following hash table can be maintained.

| Range | | % Increase in packet size |
|---|---|---|
| 0-5 | Kbps | −15% |
| 5-10 | Kbps | 0 |
| 10-15 | Kbps | 10 |
| 15-20 | Kbps | 17 |

These are but exemplary values, of course, and other values can be determined through routine testing and used in other environments. It is expected, for example, that the overall packet sizes (i.e., the ceiling and floor thresholds) may vary by as much as 100% for a range of available transmission speeds.

Similarly, a percentage increase (or decrease) in the packet size depending on the processing speed and battery life and stack memory on the client device are also maintained.

Finally, on top of this, each factor (bandwidth, processing speed, battery life etc) is preferably assigned a contribution margin. The greater the contribution margin, the greater the influence of that factor in determining the packet size. The contribution margins are like vectors specifying weighting factors assigned to the various packet size determinants, and can be specified differently for each client device, or for a particular subscriber, or even a particular session ID. For example, a cell phone may have a different set of contribution margins than a Palm Pilot, due to disparities in battery performance, modem behavior/characteristics, etc. The only criterion, of course, is that the sum of the contribution margins should add up to unity (1).

In this manner, a packet size is determined for each client device, and for each data session, to improve an overall performance for the system. Thus, each different type of client device can conceivably use different types of hash tables, even for the same transmission bandwidth, battery life, stack memory, etc. The preferred settings for each device can be gleaned through routine testing using a variety of test conditions.

A flow chart for determining the preferred packet size is shown in FIG. 10 and is explained below:

Step 1001: The ceiling and floor parameters for the packet size, as well as a reference starting size, are read in.

Steps 1002-1004: The contribution margins for bandwidth, processor speed and device memory are read in.

Step 1005: Depending on the pre-computed weights the contribution margins are used to add or subtract corresponding values from the reference packet size to generate a calculated packet size.

Step 1006: Check to see if calculated packet size is greater than the ceiling value.

Step 1007: If the calculated packet size is greater than the ceiling value, then the ceiling value is set to the new calculated packet size.

Step 1008: If the calculated packet size is not greater than the ceiling value, check to see if the calculated packet size is less than the packet floor value.

Step 1009: If the calculated packet size is less than the floor value, set the floor value to the new calculated packet size.

Step 1010: If the calculated packet size is greater than the floor value, set the ceiling as the new packet size.

Server 109 and the client device cooperate to perform a heuristic determination of the available bandwidth for creating the hash tables noted above. In a preferred approach, the HTTP request from the device to server 109 is used to determine the available bandwidth. A timer is set on the device immediately following the request to the server. The server responds by sending the device a predetermined amount of data. When the device receives the data, the elapsed time between the initial request and the response is calculated. The procedure is preferably repeated for a number of times (which is configurable but is preferably at least three), each time with different amounts of data transfers from the server to the device.

The hypothesis used in the present invention is that a required to get all the data completely from server 109 is a function of both the available bandwidth and a constant that needs to be accounted for—i.e., the network delay. Thus, by using the time delay for more than one transaction, the network delay factor can be negated, and the bandwidth can be computed to an acceptable degree of error.

While the present invention uses this type of approach, it will be apparent to those skilled in the art that other well-known benchmarking tools for determining available channel bandwidth can be used in embodiments of the invention. In some instances estimates based on actual prior transmissions (to the extent they are substantially contemporaneous) can be used to estimate a channel bandwidth.

Thus, in one example, if an available bandwidth is about 17 Kbps, a packet size is increased as a result of just the bandwidth factor by 17%. Therefore if the default packet size is set to 4 KB, the new packet size would be 4.68 KB. Assuming the processor speed and battery life contribution to packet size are minimal, this figure would be rounded up to 5 KB.

Again, if the new packet size that is determined by this algorithm is greater than the packet ceiling size, the packet size is set to the ceiling value instead. Since this is a heuristic algorithm, individual users can customize the algorithm as desired by changing the weights that are assigned to the individual factors or the ranges within the factors.

Encryption

Encryption is also flexibly incorporated into the present invention through an encryption process which performs the following basic functions within Smart Packetization module 112:

Looking up encryption preferences

Invoking an appropriate encryption module

Forming the header parameters to identify the encryption type

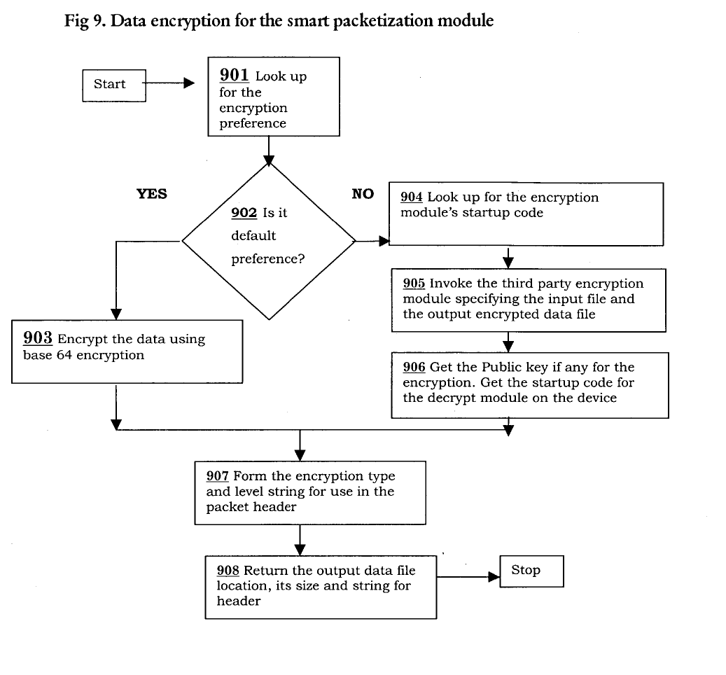

FIG. 9 shows the various steps involved for data encryption in Smart Packetization module 112:

Step 901: Consult an encryption preference database (not shown) to get any encryption preference identified for the vendor or for this specific data transmission. As mentioned earlier, the invention allows third party encryption algorithms to be used. This procedure looks up any default encryption preferences from a database (not shown). If a preference is not specified then a default encryption is used.

Step 902: Compare the preference with the default. If they are the same, go to step 903 else go to step 904.

Step 903: Use Base 64 encryption for the data. Go to Step 907.

Step 904: The startup code for the encryption module must be registered. This code is invoked using appropriate parameters. This gives flexibility to plug in custom encryption modules into the current system.

Step 905: Invoke the appropriate encryption module by invoking the start up code and passing the data and the other required parameters. It is executed as a separate process. The third party module is preferably built as Enterprise Java Beans or as procedures written in C language. Server 109 performs either an EJB lookup followed by the appropriate method invocation or a native method invocation to execute the appropriate encryption routine.

Other well-known options can be used instead, of course, for such third party module.

The input file name and the output file names are passed in parameters along with application specific data. The file is then encrypted by this procedure.

Step 906: If the encryption module returns a public encryption key, it needs to be put into the header information for the receiver to decrypt the data.

Step 907: Form the header variables about the type, level and the public key information for the encryption. In order to decrypt the data in the device, some custom information needs to be provided. In case a custom application or routine is used for the purpose of encryption, the device assumes the availability of a client side routine for the purpose of decryption. If the default 64 bit encryption is used, the software on the device will be able to decrypt the data. The header for the packet contains information on the type of encryption and the level of encryption as noted earlier. If custom parameters need to be passed to the decryption modules, they are also included in the header information. The size of the decrypted data is also needed. This is the information used to determine the number of packets that the encrypted data needs to be split into.

Step 908: Return the encrypted data to Smart Packetization module 112.

The above of course is merely an example of a preferred encryption process that could be used in an embodiment of the present invention, and that variations on the above are clearly suitable for many applications. Other embodiments of an encryption process could perform additional functions in addition to those identified above. Furthermore, in the interests of better explaining the details of such process, many conventional implementation-specific details well-known to those skilled in the art have been omitted, but could be incorporated in embodiments of the present invention.

Finally, while the functions and features described above for the encryption module are unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

State Information

The State Information Module (113 in FIG. 1) records the state information about a particular client device. This module also determines and checks the list of software that can ‘fit’ the device based on the state information gathered.

For example, during a device initiation process, the device can provide a number of details to server 109 concerning technical features of the device, including but not limited to information such as non-volatile data storage available, free system memory on the device, a battery life, available bandwidth, a screen size, sound and graphics capabilities, the type of processor, the type/availability of peripheral devices that have been attached to the device, etc. Based on this information, state module 113 performs a look up in a software application database (not shown) to look up and find an appropriate set of applications/games that can be downloaded to the device.

FIG. 15 shows the different parameters that are considered by State module 113. This module is responsible for tracking and recording the state of the different devices that connect to the server for request processing. Again, an initial handshake with the device provides the device ID and the device state information. State information of the device contains the following information.

The Bandwidth for the last login (1510)

The total memory and free memory on the device (1520)

The type of processor for the device (1530)

The remaining battery life for the device (1540)

The peripheral devices that are attached to the mobile device (1550)

The type of display unit for the device (1560)

The locale of the mobile unit (1570)

List of new software installed since last login to server (Optional) (1575)

Version of the client installed on the device (1580)

This is but one set of variables, of course, and other useful technical and subscriber related data can be used to form a device state record depending on design criteria and needs for a particular application.

The information gathered can be used for better profiling of users and devices. The total memory and free memory on the device can be used to provide a list that fits the memory limitations of a device. The type of processor provides information regarding the level of encryption that needs to be used. Decryption is processor intensive, which can consume battery life on the device. Certain types of peripheral devices may be required for proper use of some types of software. The locale of the mobile unit is important so that the messages from the server can be displayed in the appropriate language. The list of software since last install is an optional field that maybe sent to the server by the device. Only certain types of devices support this.

The above of course is merely an example of a preferred device state gathering process that could be used in an embodiment of the present invention, and that variations on the above are clearly suitable for many applications. Other embodiments of the State module 112 could perform additional functions in addition to those identified above. Furthermore, in the interests of better explaining the details of the device state data gathering process, many conventional implementation-specific details well-known to those skilled in the art have been omitted, but could be incorporated in embodiments of the present invention. For example, other types of information could be sent from the device to the client based on system performance requirements, subscriber status, service requirements, system status, etc.

Finally, while the functions and features described above for the State module 112 is unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

Alarm Processing

The Alarm Propagation module (116 in FIG. 1) checks to see if any alarms need to be sent to a particular device. The alarms can be configured based on a variety of factors, including for example whether a particular software application is installed on the machine or in response to direct alerts configured and sent by ASPs 104 or Data distributors 105.

Alarms can also be specified to have an associated priority, which can be set to any number of different levels as maybe appropriate for a particular system. The action and data associated with the alarms can also be packaged into a combined response sent to the device.

For example, a vendor can send an alert about a virus that can make a particular type of device vulnerable. The vendor can provide additional information to the user along with either an updated virus patch or a URL. The vendor can set a priority for the alarm. This can be sent as an alert packet and transferred to the device, or in combination with the virus patch itself in a combined alert/data packet data session.

Users of mobile devices embodying the present invention can choose to subscribe only to alarms of certain priority, or even turn them off altogether. Alarm module 116 is responsible for coordinating alarm processing on server 109 and interactions with client devices to ensure accurate propagation of alarms.

FIG. 11 shows the general sequence illustrating how alarms are propagated in the present invention from server 109 to one or more client devices. To better explain this aspect of the invention, it is helpful to consider the distinction between an “alarm” as disclosed herein, and a simple “message.”

A “message” generally is understood to contain only text information that must be displayed on a device. For example, this could be a promotional message such as “Software Nintendo available for one month trial download” or “Your last payment of $32.56 has been charged to your credit card account,” or even other types of text received from pure text messaging systems.

In contrast, an “alarm” as described herein can contain a variety of contents, including textual information, an action (command) as well as data associated with an action. An example for this is as follows. An alarm about a virus, for example, may contain text information identifying a particular virus, along with an associated action of scanning for special types of data files (or databases) on the device. This information must be propagated to the device. The action could further include an automatic downloading of a virus patch for the device. Other variations will be apparent to those skilled in the art.

This invention also preferably allows a vendor or a distributor to create an alarm from a web interface. The user associates a script or a set of commands as part of the action for the alarm. A data association could be a virus patch for the particular alarm.

The vendor is also able in certain embodiments to configure the type of devices the alarm needs to be propagated to and the priority of the alarm. As mentioned earlier, devices can be set to subscribe to all alarms, to certain alarms by certain vendors, or alarms of specific priority. Again, different alarm triggering mechanisms can be specified within embodiments of the present invention using conventional techniques.

An alarm is then ‘bundled up’ into a data packet by server 109 for propagation to the device. The header of the packet is used to distinguish such packet as an alarm type packet. The alarm message and the specified alarm action are also preferably encoded into the message content.

Thus, on the device side, a GUI manager displays the alarm message. An alarm message box is also displayed, requesting permission to proceed with the specific alarm actions associated with the alarm. If the user chooses to proceed, a command interpreter on his/her device executes the alarm action. The data from server 109 (i.e., such as a virus patch) can then be transferred to the device as an automatic download.

FIG. 11 shows the various steps involved in both alarm creation by a vendor and an alarm download to a particular device. The steps are explained below.

Step 1110 In this step, the user (data distributor) selects the type of device the alarm should be propagated to. As noted earlier, alarms can be sent on a broadcast type basis (based on some set of criteria to be met by a device or subscriber) or more carefully targeted (i.e., even to specific users). Thus, the vendor has the option of sending the alarm to a specific device as well.

If the alarm is decided based on type, it is propagated to all the devices of that type following the next data request session from such type of device. The data distributor can also send alarms based on specific criteria. For example: the alarm recipients could be narrowed down to all the mobile users of a specific type who have installed a specific application between a start date and an end date. Other examples will be apparent to those skilled in the art, and the invention is by no means limited to any particular variation.

Step 1120 At this point the user can create a message and a command script for the alarm. The message is used to display some useful information to the user. For example: the message could read—“E-Trade has detected a security hole in the latest version of the software for Palm A security patch will now be downloaded to your device.” The client (optionally executes the command script after the message is displayed on the device at the user's prompting.

Step 1130 Any data that is associated with the alarm now is uploaded to server 109. For instance, this could be the security patch mentioned in the example in step 1120.

Step 1140 The distributor can set or associate a priority for the alarm. Thus, client devices can set download options to download alarms of only a certain level of priority.

Step 1150 This mechanism allows a data distributor to test the alarm and confirm its operation. Preferably the alarms are sent only after the test has been confirmed. This eliminates the possibility of malicious alarms and data being downloaded to a device.

Step 1160 After testing, the alarm is flagged as being ready for propagation. Any and all devices, which fall into the target recipient class for the alarm, will see the alarm following their next data request. Again, as mentioned above, distributors have a variety of options for specifying the types of devices and/or subscribers who should receive a particular alarm.

The steps involved in the Alarm Download to a device are explained below. It is assumed at this point that an alarm is ready and pending for propagation to the device in question.

Step 1170 shows an HTTP request from the device.

Step 1180 An alarm manager at server 109 is invoked to determine if there are any alarms that need to be propagated to the device. A lookup is performed on an alarm database (not shown) to check for appropriate alarms. If alarms need to be sent to the device, step 1190 is invoked. As discussed earlier, alarms can be set by broad categories, or by specifically targeted criteria. For instance, alarms could be for all devices of a certain type or for users of a specific application. At the most primitive level, a data distributors could send an alarm to a specific device (specific device ID) or subscriber (if the latter is otherwise known through a software ID associated with an application for example).

Step 1190 At this point, the Smart Packetizer module 112 is invoked to packetize the data as noted above. The data is sent the device through an HTTP response in step 1195.

Step 1195 This routine sends the alarm in the form of a response to the device for the data request.

The above of course is merely an example of a preferred alarm system that could be used in an embodiment of the present invention, and that variations on the above are clearly suitable for many applications. Other embodiments of the alarm system could perform additional functions in addition to those identified above. Furthermore, in the interests of better explaining the details of the alarm system and processes, many conventional implementation-specific details well-known to those skilled in the art have been omitted, but could be incorporated in embodiments of the present invention. For example, other types of alarms could be sent from the server to the client based on system performance requirements, subscriber status, service requirements, system status, etc.

Finally, while the functions and features described above for the alarm module 116 is unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

High Availability

The High Availability Module (117 in FIG. 1) is a programmatic extension of the clustering functionality that is provided by various hardware vendors. Many Hardware vendors like Sun Microsystems, IBM, HP support hardware clustering of two or more systems. In such cases the hardware is capable of having a primary and secondary configuration.

This module in the present invention extends the functionality of clustering. It uses the native libraries that are provided by the hardware vendors to enable a fail over and fail back of systems when there are hardware issues with one of the servers in the cluster. This ensures that the systems are still accessible when one of the servers needs to be shut down for maintenance work. This also provides a mechanism for load balancing.

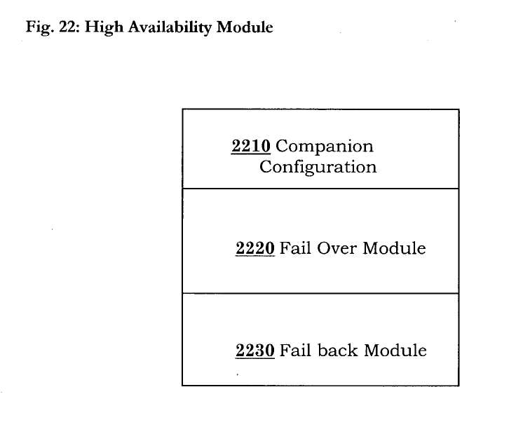

The high availability module in the present invention ensures scalability and fault tolerance for the system. The high availability module performs the following procedures, which are indicated generally in FIG. 22.

Companion Configuration (2210)

Fail Over Module (2220)

Fail Back Module (2230)

a) Companion Configuration: (2210 in FIG. 22) This procedure uses the hardware clustering capability to create companion servers for server 109. This ensures that when a server ‘goes down’ due to a hardware error or software error or for a system reboot, the cluster configuration takes the existing connections and migrates them to a Secondary server (not shown). This procedure creates a primary companion mode, a secondary companion mode as well as a synchronous mode for the servers. This is a useful functionality to maintain warm standby systems.

b) Failover and Failback module: (2220 and 2230 in FIG. 22) These procedures are built on top of the vendor specific APIs to support failover of the server connections to the secondary server if the primary server is inaccessible. The EJB entity that refers to the data with old connections can continue to retrieve data without having to disconnect. New HTTP connections for data request from the devices are disallowed and return an error. When the primary server becomes accessible again the connections are restored to the primary server. New connections proceed normally.

It will be understood by those skilled in the art that the fallback and failover mechanisms described herein can be implemented in a variety of ways that are compatible with the teachings of the present invention.

Application Integrators

An Application Integrator module 118 (FIG. 1) is used to fetch data from a third party application or legacy systems. A set of adapters uses an Application Programmer Interface, which can be used in embodiments of the invention, to transport data that resides in third party applications or legacy systems onto a mobile device.

For example, an enterprise may have its service force information on an IBM mainframe machine and some of the service pricing information and technical knowledge base in a more updated DB2 system. By creating adapters that communicate with the legacy systems using native interfaces or by JDBC-ODBC Bridge, data can be extracted from these systems as well. This data can be packetized and transported to different devices in the same manner as described above.

Accordingly, a server 109 can be adapted as a centralized distribution point for a variety of disparate computing platforms used by an enterprise. The software routines for embodying application integrators can be implemented by those skilled in the art in accordance with the present teachings using a variety of conventional programming techniques for any particular environment.

Reports

Another facet of the invention concerns a Reports module 114 (FIG. 1) which is useful for performing data processing on certain information collected from client-server interactions, and stored in the data repository. These reports are used by vendors, for example, to generate several standard reports like the following:

Number of Downloads

Revenue by software

Billing information

Space utilization on the server and the device

Feedback from the customers about the software

Additional customer demographics reports like the following can also be obtained:

Download based on Gender/Age/Location

Correlation of downloads based on cost/space/graphics/sound capability

Regression analysis of downloads based on price

Report module 114 is highly extendable and has adapters for third party CRM applications so that software vendors can perform help desk solutions using the system.

The most useful aspect performed by Report module 114 is a function generally described as “asset management.” Asset management can be considered to be systems specific reports for system administrators.

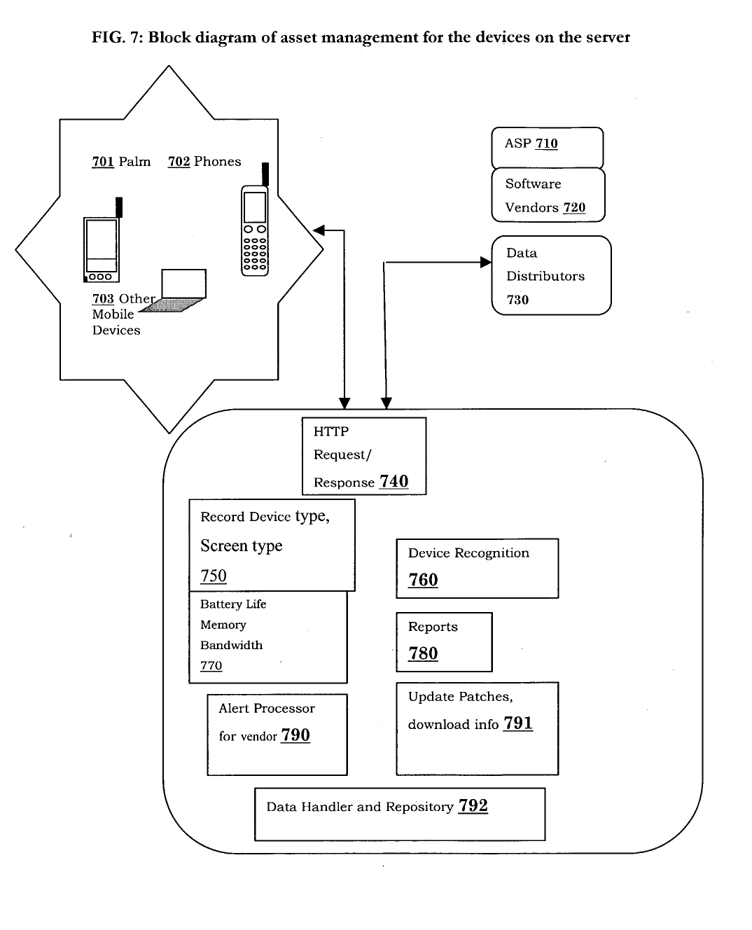

FIG. 7 is a block diagram illustrating how asset management is performed on server 109 for the various client devices by Report Module 114. Unless otherwise indicated, like referenced objects in such drawing are intended to denote like referenced objects from earlier figures.

Blocks 701, 702, 703 These are the varied types of mobile devices that request data from a server 709. These devices have client side software installed to make the data request to the server in the manner described earlier.

Blocks 710, 720, 730 These are the vendors, ASPs and Data distributors who are the owners of the data also as noted earlier. The reports and asset management capability of the present invention gives system administrators for such entities knowledge of the devices that have deployed their application. They can also get a mobile device count and detailed property explanations of the mobile devices. These reports are preferably made available through a web interface.

Block 709 corresponds to server 109 as noted earlier, which also includes a number of asset management specific modules, including:

HTTP Request/Response 740 is a servlet interface on server 709 for the devices as well as the data distributors. The servlet invokes the appropriate modules depending on the type of data requests it receives. Thus, it acts as a form of communications traffic monitor for observing and identifying requests made by the various mobile devices.

Record Device type module 750 is responsible for updating the data repository on the type of device that has made a request for data. This module also retrieves information on the applications that can be installed on a particular type of device.

Battery Life, Memory and Bandwidth are also recorded by a corresponding module 770 and the data repository is updated with this information.

Device Recognition module 760 is responsible for detecting the device based on the information passed from the device to the HTTP Request module as a part of the request for data.

An Update Patches/download info module 791 is responsible for recording the patches that need to be applied to applications and to devices of certain type. Data Distributors, Vendors and ASPs can upload patches and request that they be applied to specific applications and/or devices of a certain type. When such devices connect to server 709 during a data request, the information in this module is queried to check for patches or updates to software. If patches need to be downloaded to the device the appropriate alarm is sent to the device to inform the user of the update or patch.

Data Handler and Repository 792 corresponds to block 119 (FIG. 1).

The above of course is merely an example of a preferred report module that could be used in an embodiment of the present invention, and that variations on the above are clearly suitable for many applications. Other embodiments of the report module could perform additional functions in addition to those identified above. Furthermore, in the interests of better explaining the details of the report module, many conventional implementation-specific details well-known to those skilled in the art have been omitted, but could be incorporated in embodiments of the present invention. For example, it will be apparent to those skilled in the art that other types of device/subscriber information could be identified, collected and analyzed, and other types of reports could be generated based on the same. While certain modules are identified within an asset management system as performing specific functions, it is entirely possible that such modules may differ in any final commercial implementation, and that the functionality performed by two or more modules identified above could be integrated and performed by a single module instead.

Finally, while the functions and features described above for the report module 114 is unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

Device Side

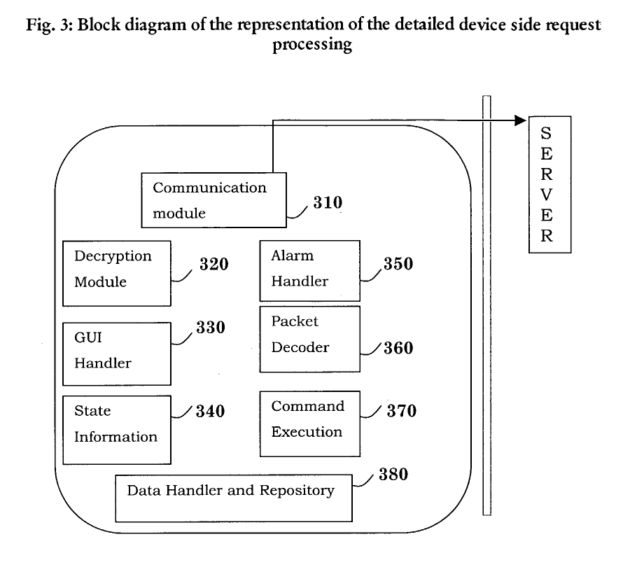

FIG. 3 is a block diagram illustrating the basic components of a mobile computing device (101, 102, 103 in FIG. 1) configured in accordance with a preferred embodiment of the present invention. The various functional blocks indicated are:

Communication Module (310)

Decryption Module (320)

GUI Handler (330)

State Information (340)

Alarm Handler (350)

Download Module (360)

Command Execution Module (370)

Data Handler and Repository (380)

Each of the blocks is explained in detail below.

Communication Module 310. Communication module 310 on the device initiates the HTTP Request, which is a part of an initial handshake between the server and the device discussed in detail above. Communication module 310 is designed to support any default wireless service communication protocols on the device. The communication module is used primarily for the transfer of wireless data between the server and the device. The communication module can also be used to determine the available bandwidth that is available at the point of initiating a communication to the server, in a manner discussed earlier.

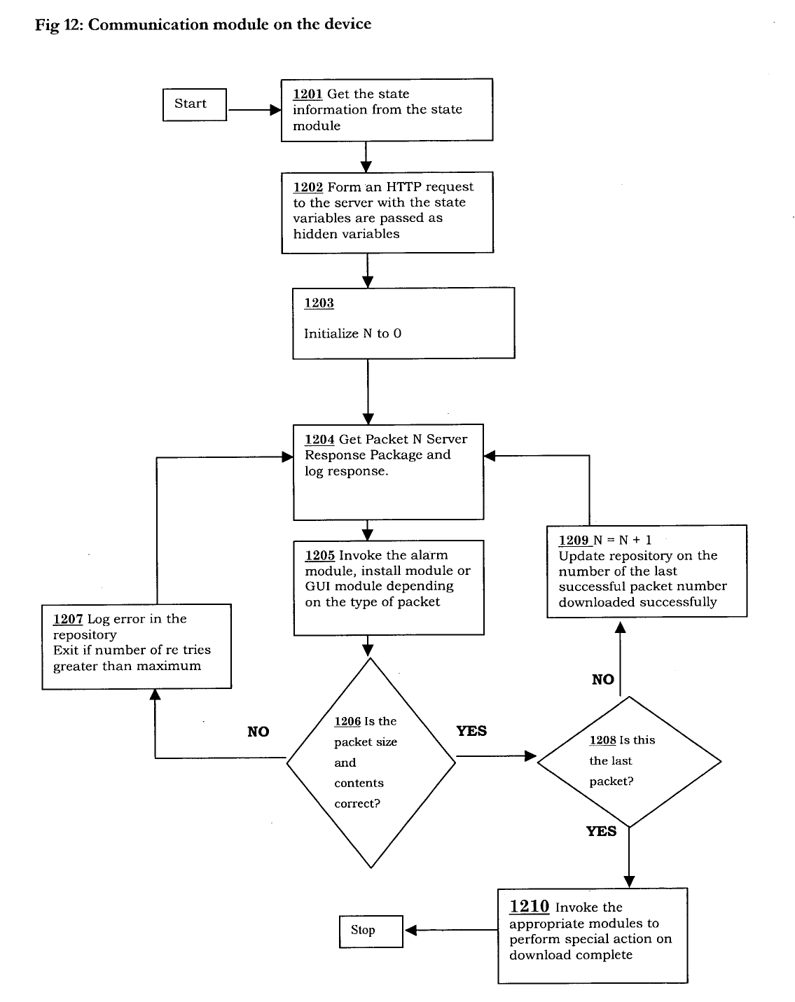

The detailed description of the functions and operations of Communication module 310 on the device is given in FIG. 12.

Communication module 310 preferably uses a standard UDP protocol for communicating data. On a Palm VII a communication module is built on top of InetLib libraries and APIs. Thus, the device uses device specific library calls and libraries to communicate with server 109.

The preferred protocol for communication between server 109 and the client device is standard HTTP. A communication timeout interval (dwNumberOfRetries') determines a time in seconds that the device will wait until it gets a response. Communication module 310 initiates the handshake with the server. Furthermore, such module invokes a state module on the device and sends some device specific information to server 109 for the purpose of device identification which can then be saved on server 109 within a data repository. If a communication with server 109 fails, a log is maintained on the latter.

The basic operations performed by communications module 310 are identified in FIG. 12 as follows:

Step 1201 Communication module 310 is initiated by invoking the state information module (discussed below) on the device. The state information detects the battery life remaining, the total memory on the device, the free memory, the type of display and the peripheral devices that are attached to the mobile device. As noted earlier, other types of device specific information could also be used as part of the state information.

Step 1202 Communication module 310 initiates a HTTP request to server 109.

Step 1203 The state information values from step 1201 are passed to server 109. The latter responds by sending data packets to the device. The packets can contain different types of data as noted above. The action required on the device depends on the type of data received from server 109. The data is sent as several packets, and to accommodate this a variable “N” is initialized to 0 by Communications module 310.

Step 1204 Packet #N is received from the server.

Step 1205 Depending on the type of packet, different modules on the device are invoked to handle the data in the packet received.

Step 1206 A check is made to see if the size of the packet matches the specified size. If the size does not match, proceed to step 1207, else proceed to step 1208.

Step 1207 Log an error in the local repository and increment a transmission failure variable indicating a number of unsuccessful attempts. If the transmission failure variable has a value greater than the number of retries, the Communication module 310 is exited with an appropriate error.

Step 1208 A check is made to see if the packet being transferred is the last packet in this data transfer transaction. If so, proceed to step 1210, else proceed to step 1209.

Step 1209 Increments the value of N and updates the repository to identify the number of the last packet that has been successfully downloaded. Proceed to step 1204.

Step 1210 At this point, all data for the request has been successfully downloaded to the device. The action following the download depends on the type of data that has been downloaded. For example for an Alarm, an Alarm module (discussed below) needs to be invoked. If the request is for an application install, a Wireless Install module (discussed below) is invoked which uses the native operating system APIs to register the downloaded data as a valid application.

The above of course is merely an example of a preferred communications module that could be used in an embodiment of the present invention, and that variations on the above are clearly suitable for many applications. Other embodiments of the communications module could perform additional functions in addition to those identified above. Furthermore, in the interests of better explaining the details of the communications module, many conventional implementation-specific details well-known to those skilled in the art have been omitted, but could be incorporated in embodiments of the present invention. For example, other types of device state information could be sent from the server to the client based on system performance requirements, subscriber status, service requirements, system status, etc. Furthermore, some of the device state information maybe communicated at different times, over different communications links, and not necessarily with the first handshaking operation performed with server 109. For instance, device state information maybe uploaded to server 109 as part of a separate upstream operations channel, or even embedded in an acknowledgement back to server 109, etc. In a cell phone embodiment, for example, a lot of device state information can be extracted during a voice based telephone call prior to a formal HTTP data request and passed on to server 109. Similar examples will be apparent to those skilled in the art from the present teachings.

In other instances device state information may be “inferred” rather than directly measured and transmitted. For example, since the packet size for a data transmission is based in part on remaining battery life, it may be useful to estimate battery life in situations where successive downloads are being made to the same device. In other words, a remaining battery life may change dramatically by the end of a first download, and by estimating a reduction in battery life, a second immediately following download can be configured with different packet transfer parameters (including packet length) to accommodate such change in the device.

In addition, various types of information, routines, etc., maybe automatically pushed by server 109 onto a client device as a way of enhancing performance and reducing latency as experienced by the user. This type of push capability can be regulated by users of such devices to avoid conflicts and unnecessary downloads. In other words, they can elect to opt out, or to opt in based on such push satisfying certain criteria. For example, a particular type of encryption may become widely adopted and used to encrypt applications. If a user device does not already include a decryption module for such encryption code, certain applications may be inhibited or blocked from being downloaded to a particular device. Other examples will be apparent to those skilled in the art.

In some embodiments of the present invention, a server 109 automatically detects such potential need, and then distributes such decryption module automatically to subscribers who have elected to receive such types of updates, and without requiring a specific HTTP request from the client device. In this respect Server 109 may incorporate a number of different well-known artificial intelligence algorithms for predicting the desirability and usefulness of any particular feature, data or code for a particular user/device, and ultimately determining whether to “push” such data.

Finally, while the functions and features described above for the communications module 310 is unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

Decryption Module 320 The packets that are transported from server 109 to the device are encrypted to protect the data as described in detail above. Decryption module 320 is responsible for decrypting this data after it is received on the device.

As also noted earlier, server 109 has the option of using standard base 64 encryption techniques. The packet header contains information to determine the type of encryption. If default encryption is used, Decryption module 320 decrypts the data. On the other hand, the server has the flexibility to use third party encryption techniques to encrypt the data. In this case, the header for the data packet contains information on the type of encryption and further identifies a custom module to be invoked on the device to decrypt the data.

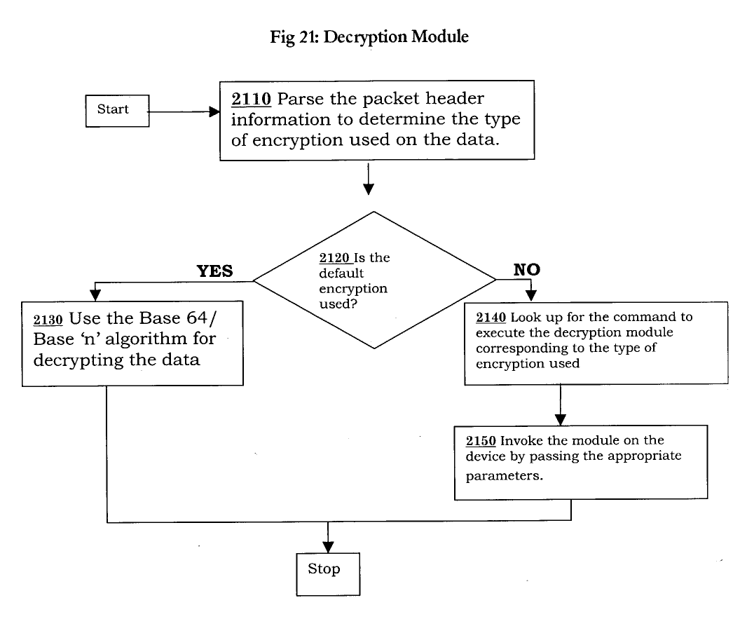

FIG. 21 shows the functions performed by Decryption module 320. This module is used to decrypt the data in the packets. An application developer using a particular customized encryption routine should ensure that the corresponding decryption modules are made available on target devices. When the data is split into packets on server 109, the packet header contains the following information regarding the encryption:

Encryption Type

The module name and parameters to be passed to the decryption module on the device

The Decryption module will be able to use the default base 64 decryption or invoke the third part decryption modules. The command execution module is invoked to use the custom decryption modules.

The general functions performed by Decryption module 320 include:

Step 2110 The packet header contains information on the type of encryption that was used on the data. This information is parsed from the packet header.

Step 2120 A determination is made to see if the default encryption was used. If so, the default decryption module (Base N) is invoked.

Step 2130 The standard base ‘N’ algorithm is used for decryption. It can be configured to be a Base 64 or Base 128 bit algorithm. The algorithms for this are well known, and are not material to an understanding or use of the present invention.

Step 2140 If a custom encryption module has been used, the corresponding decryption module must exist on the device. This step involves the look up into the local repository on the device to determine the matching decryption module for the type of encryption used.

Step 2150 This decryption module is invoked bypassing the appropriate parameters. These could also be third party decryption modules, of course, that will need to be invoked by passing a certain set of parameters specific to such modules.

The above of course is merely an example of a preferred decryption module that could be used in an embodiment of the present invention, and that variations on the above are clearly suitable for many applications. Other embodiments of the decryption module could perform additional functions in addition to those identified above. Furthermore, in the interests of better explaining the details of the decryption module, many conventional implementation-specific details well-known to those skilled in the art have been omitted, but could be incorporated in embodiments of the present invention. In addition, some embodiments may not need encryption, so this module may not operate on all data transfers. Furthermore, the type of encryption may be defined within the data content itself, and not as part of the packet header.

Finally, while the functions and features described above for the decryption module 320 are unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

Alarm Handler 350 As discussed above, Alarms are associated with message, data and commands (or actions). Alarm module 350 on the device side invokes a GUI handler 330 to display the message, and a Command Execution module 370 to execute the commands and direct communication module 310 to retrieve additional data if needed. If the data is sent as packets, control is routed to Packet Decoder module 360 to perform a smart download of data. Communication module 310 notifies Alarm Handler module 350 to handle alarm type packets.

Taking the example of a virus patch download, Alarm Handler module 350 parses the packet format and Packet Decoder 360 is invoked to get header information for the packet. From the header information, Alarm Handler 350 extracts the message content for the alarm. Following the header and the boundary information in the packet is an action command for the device. Following yet another boundary is the operand data for the action (or command to download the data).

In this example, the message content could include the text string ‘Your software download status indicates that your device is vulnerable to NIMDA_FOR_PALM’. The message is automatically configured to be in the correct language for the particular device/subscriber. Alarm Handler 350 invokes GUI handler 330 to display the message to the user.

The actions for the Alarm could include such operations as backing up the current data files to server 109, or simply renaming certain data files. Generally speaking, each mobile device includes device software with a published set of commands can be executed on the device, and the Command Execution module 370 executes these as actions in response to alarm messages as may be necessary. The Communications module 310 is invoked again to download any data if the data is already not part of the current packet.

Alarms are also associated with a priority. The vendor sets the priority. Users of mobile devices can subscribe to alarms from certain vendors or alarms based on category. Checks for alarm subscriptions are done at the server. Thus, alarms are not downloaded to a device unless they are subscribed to.

The above of course is merely an example of a preferred alarm handler module that could be used in an embodiment of the present invention, and that variations on the above are clearly suitable for many applications. Other embodiments of the alarm handler module could perform additional functions in addition to those identified above. Furthermore, in the interests of better explaining the details of the alarm handler module, many conventional implementation-specific details well-known to those skilled in the art have been omitted, but could be incorporated in embodiments of the present invention. In addition, some embodiments may not support alarms, so this module may not be used on all client devices. Furthermore, the format of the alarms may be varied from that illustrated above, so that the type of alarm may be defined within the data content itself, and not as part of the packet header. The other fields appropriate to an alarm may be distributed differently as well within a packet within the teachings of the present invention.

Finally, while the functions and features described above for the alarm handler are unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

GUI handler 330 is responsible for displaying information on screens on the device. Most of the screens that display information for users need to be rendered dynamically. For example, GUI Handler 330 is responsible for displaying the list of software packages that can be installed on the device. This is a dynamic list that is sent by server 109.

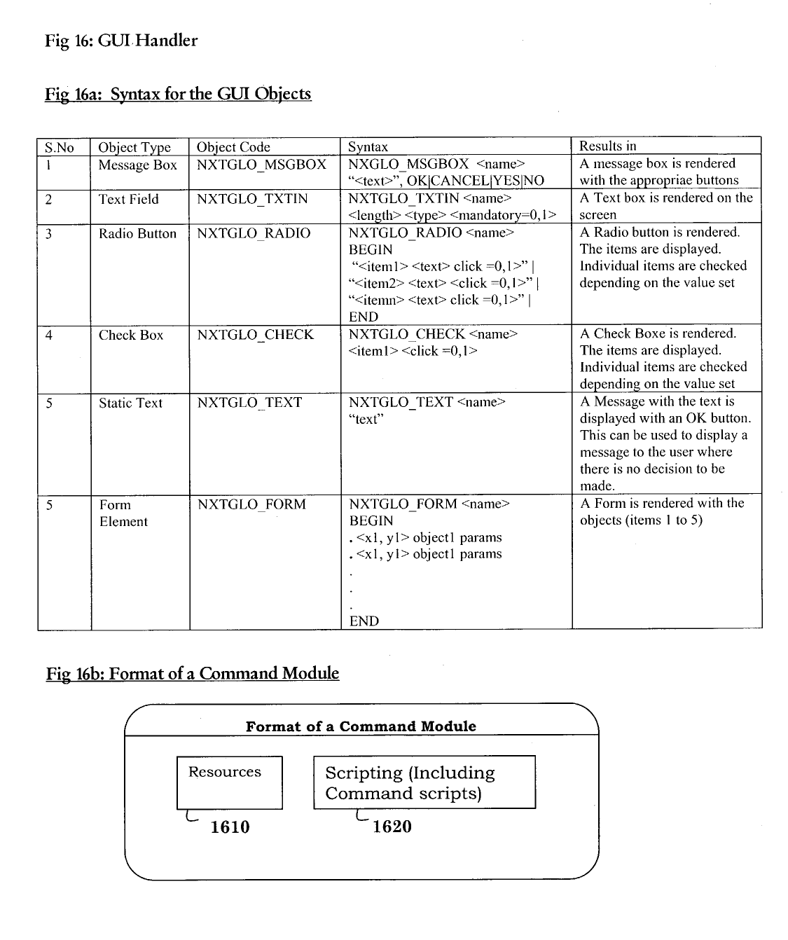

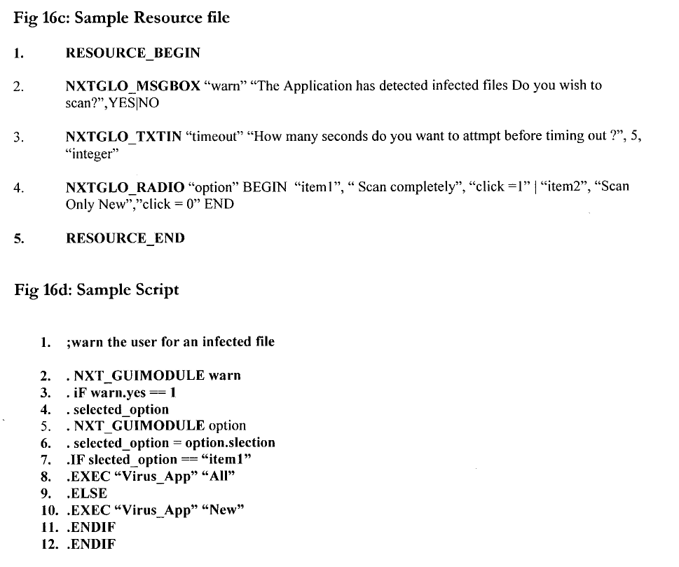

FIG. 16a through FIG. 16d show the interaction of an application running on the device with GUI Handler 330. GUI Handler 330 can interpret entries in a resource file and render the appropriate GUI entries. As shown in FIG. 16a, the application developer is preferably able to render the following GUI objects.

Message Box

Text Fields

Radio Button

Check Boxes

Static Text

Form Elements

The GUI Handler 330 renders the GUI objects on the screen. This engages the user of the device in an interactive mode where the user can make any appropriate selection. In some instances the alarms can include an audible component as well to further enhance the impact to the user.

The user selection values can be retrieved from GUI Handler 330. This is useful when an application wishes to send an alert dynamically to the device. In most cases, the text of the alarm is dynamically created. Application developers who wish to propagate an alarm should use the scripting language and the command module to create this type of interaction and tie the choice to a specific system command.

FIG. 16b shows the preferred components involved in Command Execution module 370. This is important in the context of GUI handler 330 since it interprets any alarm commands. The components of the Command Execution Module include the Resources (for screens and messages) and Scripting (for systems commands). The Resources are passed to the GUI handler to display the appropriate GUI to the user.

FIG. 16c shows a sample resource file, which contains a message box, an input text box and a radio button set. FIG. 16d shows a sample script.

In FIG. 16c, the script in the resource file is interpreted in the following way.

This is the beginning of the resource file

A message box called ‘warn’ which has a static text. The message box will have two buttons—‘Yes’ and ‘No’.

A text box resource with an input text field and a static text.

A Radio button item with two mutually exclusive possible selections.

The sample script in FIG. 16d is interpreted the following way

1—Comments, ignore the contents of the entire line

2—Invoke the GUI module to display the resource with item name ‘warn’ (This will invoke the message box declared in FIG. 16c line 2. The user will now be shown the message box and will have to make a selection of Yes or No to the message displayed')

3—If the user selected ‘Yes’ do steps from 4 to 10

4—A variable called “selected_option” is declared

5—The GUI module is invoked with the resource item ‘option’

6,7,8—If the user has selected ‘item 1’ from ‘option’ execute the module “Virus_App” and pass the appropriate parameters.

6,9,10 If the user did not select ‘item1’, execute the module “Virus_App” and pass a different set of parameters.

The following actions are taken by interpreting the scripts

| Next Token Obtained | Interpreted as | Action Taken |
|---|---|---|
| ; | A Comment | The whole line is ignored |
| . | Valid Line | Parse for the next token. |
| .NXTGUIMODULE | Invocation to the GUI handler | Parse the next token. This is the |
| | | name of the object in the resource |
| .<command> | This is either a scripting | Look up a hash table of commands. |
| | command or a System | Map them to either system |
| | command | commands or scripting commands. |
| | | Get the next token and take |
| | | appropriate action |

If there is a syntax error in the scripts, the command module displays an error message and logs an error into the local repository.

The above of course is merely an example of a preferred GUI handler module, and its components and functions that could be used in an embodiment of the present invention, and variations on the above are clearly suitable for many applications. Other embodiments of the GUI handler module could perform additional functions in addition to those identified above. Furthermore, in the interests of better explaining the details of the GUI handler module, many conventional implementation-specific details well-known to those skilled in the art have been omitted, but could be incorporated in embodiments of the present invention. In addition, as explained earlier, some embodiments may not support alarms, so this module may not be used on all client devices. Furthermore, the format of the alarms may be varied from that illustrated above, so that the message communicated may be in audible form, rather than in text form. In such instance, the GUI handler would need to include additional capabilities for controlling other peripheral I/O components of the device.

The specific fields and formats presented to the user for an alarm by the GUI handler, and/or the resource file may be different than those described above, and such variations are clearly contemplated within the teachings of the present invention.

Finally, while the functions and features described above for the GUI handler are unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

Packet Decoder 360 is responsible for ‘smart’ download of data from server 109 to the device, and works in an analogous fashion to Smart Packetization module 112 (FIG. 1). As noted earlier, for each packet, a packet header contains information on the data ID, the total number of packets, the current packet number, the packet size, the type and level of encryption that is used. If the size of a packet as specified in the header does not match the actual size received and processed, an error is recorded and the packet is requested again. Packet Decoder 360 also detects and determines the type of encryption used to encrypt the current packet, and cooperates with Decryption module 320 to determine an appropriate decryption algorithm.

After a packet is successfully handled, the packet number of the last successful packet download is stored in Data Handler and Repository 380. This helps the system recover if the communication session is interrupted or cut off. In the event of such interruption, downloading can preferably resume from the packet number following the last successful packet download, rather than from the beginning.

One well-known problem with wireless connectivity is the reliability of the signal. In the middle of a data transmission, the signal strength can change dramatically. The signal can also be lost entirely. Thus, a reliable data transmission must account for frequent connection breaks.

To solve this problem, the packet decoder of the present invention enables the user to resume the data download from a time when the connection was broken. It is done generally in the following manner.

Every successful data packet download is recorded as meta data in a repository file on the device. In the event the communication link is broken in the middle of a wireless transfer, the communication module queries the repository to determine the last packet that was downloaded. In case of a connection break the last packet information is used to reinitiate the communication with the server. The device thus requests only the data packets that follow the last successful downloaded packet.

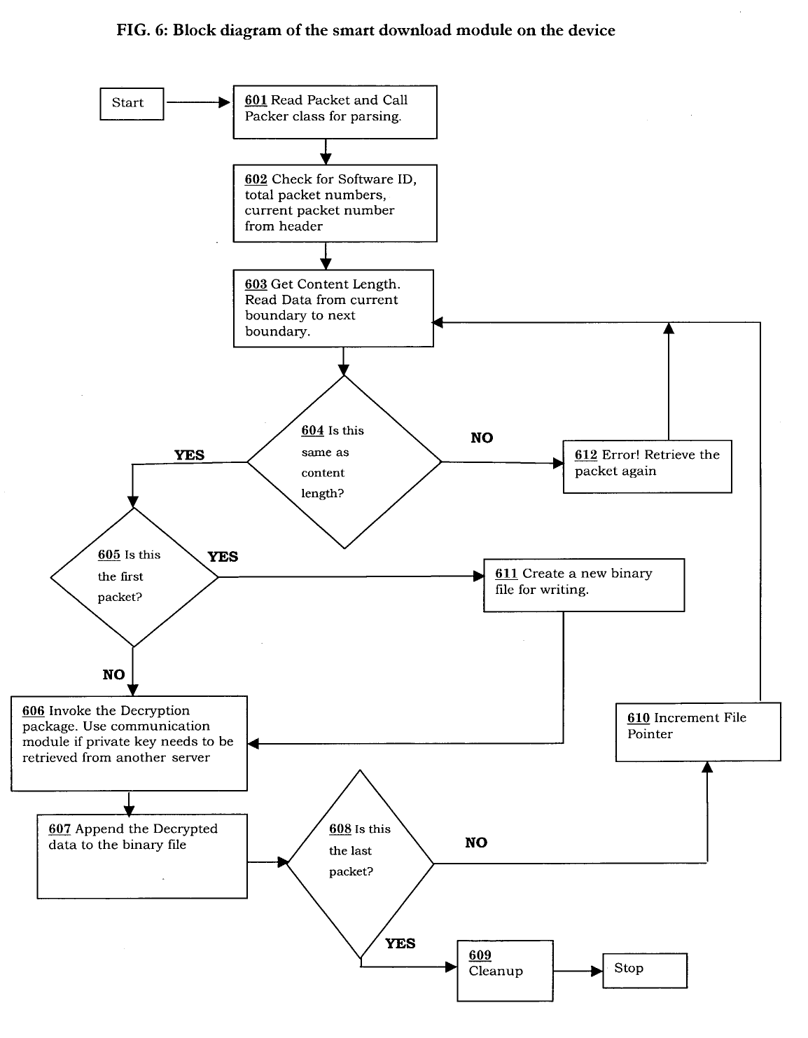

FIG. 6 shows the functions performed by a smart download routine within Packet Decoder 360 located on the client device. These include the following:

Step 601 The smart download module invokes the packer class for passing the data contents of the packet that was just received. The packer module can handle packet formats that are specific to a particular operating system. It will be understood by those skilled in the art that the packer class and packer module will vary from device to device, and are not material to an understanding of the present invention so they are not discussed at length here.

Step 602 Using the packet header, the software ID, total packet number, and the current packet number information is retrieved. Data Repository 380 is updated with this information.

Step 603 The content length is determined. This is the size of the content data in the packet from one boundary to the next boundary.

Step 604 The data from the current boundary point to the next is read. If the size of this data is not the same as the content length that was identified in the packet header, an error is logged. The packet is thus retrieved again (Step 612).

Step 605 At this point, the content data size in the packet matches the expected size. A check is made to see if this is the first packet that was received. If this is the first packet, go to step 611; else step 606 is performed.

Step 606 The data that has been received is encrypted, so an appropriate decryption module is invoked.

Step 607 The decrypted data is appended to any data in the temporary data file location. The data file is created in step 611 and contains, among other things, data corresponding to the received packets.

Step 608 Check if this is the last packet (that is, if the current packet number is equal to the total number of packets). If so, invoke a clean up module.

Step 609 A clean up module releases memory and saves the data in the temporary file location.

Step 610 If the packet is an intermediate packet within a data transmission, the file pointer is incremented so that the next iteration does not overwrite any previously written data for a prior packet.

Step 611 At this point, the packet is the first one received for the new software downloaded. A temporary file (or database record for Palm operating system) is created, and the handle is saved. This is used in steps 607 to append data and in step 609 to save the file.

Step 612: An error is recorded in the repository. The packet needs to be retrieved again.

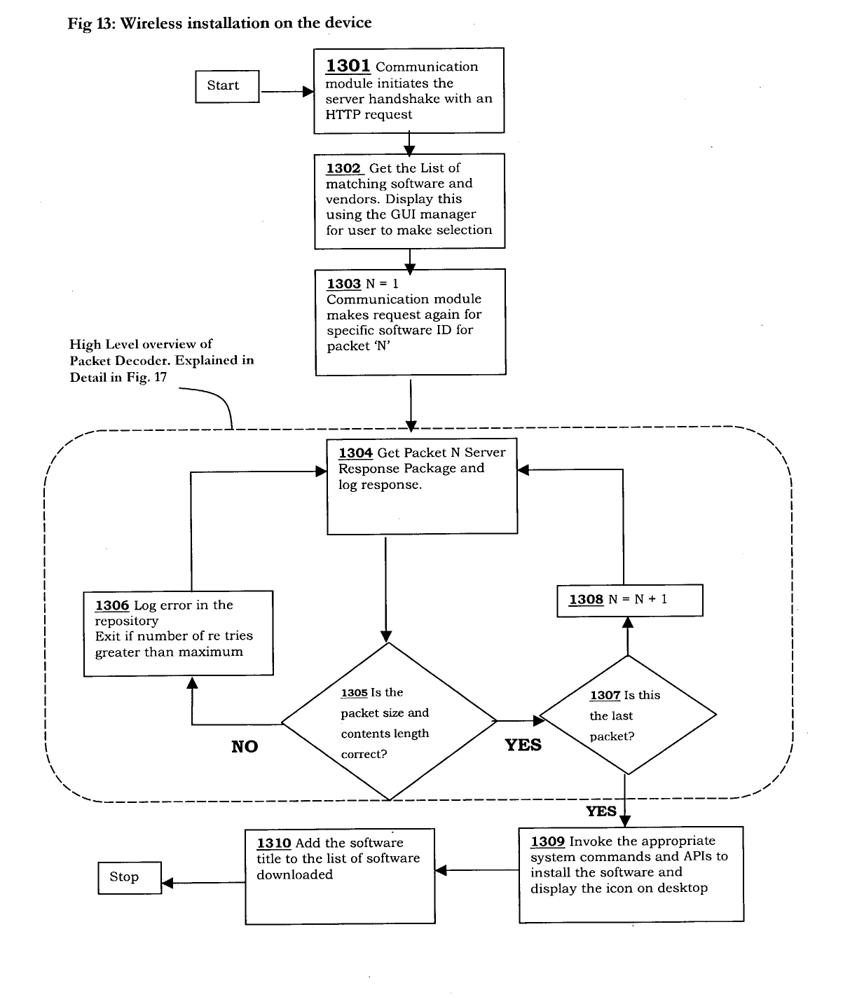

The other important aspect of smart downloads is the process of wireless installs on the device, and these are performed in a manner illustrated generally in FIG. 13.

Step 1301: Communication module 310 initiates a handshake with server 109 with an HTTP request.

Step 1302: Communication module 310 receives a list of software available for installation for the device along with the vendors of the software (or distributors). Communication module 310 uses GUI Handler 330 to display the list of vendors. Thus, when the user selects a software application from the list, the relevant application packets are downloaded from the server.

Step 1303: Counters are initialized to start a data download process. Generally speaking, steps 1304 to 1308 are repeated until the download is completed.

Step 1304: Get Packet #N from the Server. The packet must be validated and then decrypted.

Step 1305: A check is made to see if the content length matches the actual received size. If not, an error is triggered and step 1304 is retried for the same packet. If it is correct, the applicable decryption module is invoked. If the decryption and the sizes do not match, go to step 1306; else go to step 1307.

Step 1306: Here the error is logged, and control goes back to step 1304 to retrieve the packet again.

Step 1307: If the decryption is successful in step 1305, an entry is made in the receive logs updating the number of the data packet that was last downloaded successfully. A check is made to determine if the current packet number is equal to the total packets in the transmission. If so, this is the last packet, and processing continues with step 1309; otherwise processing continues at step 1308.

Step 1308: Increment the next packet number and go to step 1304.

Step 1309: All the pertinent packets have been downloaded successfully to the device. The data is appended to form a complete binary execution file, and any System APIs are invoked to register the binary file with the operating system. This could include, for example, invoking the API again to set up a visible icon on a screen of the device.

Step 1310: The local repository 380 is updated. This information is passed to server 109 as a part of the state information in the next handshake with the server. This ensures that any particular piece of software is not accidentally downloaded a second time.

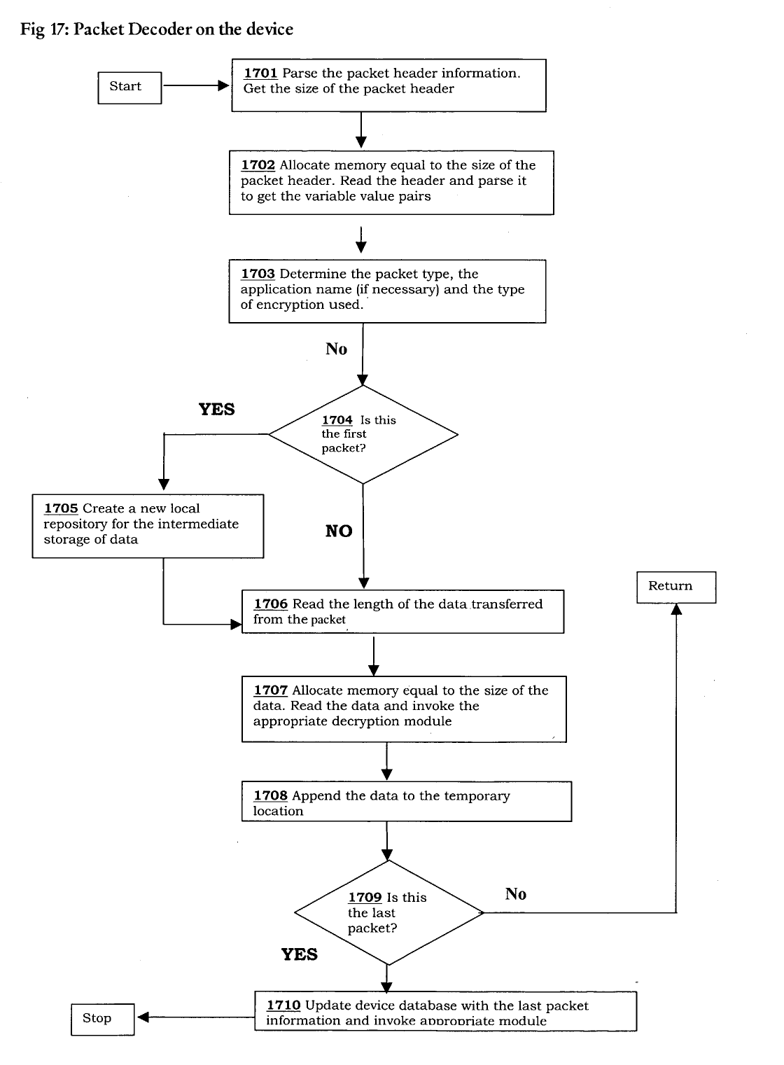

Again, as is apparent, Packet Decoder 360 is an important piece of this invention on the device side. It is responsible for parsing the packets, invoking the decryption module, decrypting the data, reassembling the packets and invoking the appropriate modules for subsequent processing of the data. Thus, steps 1304-1308 performed by Packet Decoder 360 are explained in further detail in FIG. 17.

Step 1701: The packet contents are read, and the size of the packet is determined from the header information.

Step 1702, 1703: Sufficient memory is allocated to hold the packet header. The packet header is preferably read in a single read cycle. The header is also parsed to get a list of variables and values. In the end the type of packet, the packet number, the total number of packets and the type of encryption which was used can be determined.

Step 1704, 1705, 1706, 1707, 1708, 1709: If this is the first packet, a temporary location is created for holding the data. The module then proceeds to read the length of the data that is being transferred. Memory is allocated for this data dynamically. The data is preferably read completely in one cycle. If the contents read do not match the expected length of data, there is an error. The error is logged and the packet is retrieved again from the server. Otherwise, the data is decrypted depending on the type of encryption used. Local repository 380 is updated to indicate that the last packet has been successfully retrieved from the server

Step 1710: If this is the last packet, the appropriate module is invoked depending on the type of data packet. Otherwise the function returns a success value and continues processing.

Those skilled in the art will appreciate the description above is only an example of a preferred Packet Decoder module, and its components and functions that could be used in an embodiment of the present invention. A number of variations on the above are clearly suitable for many applications. Other embodiments of the Packet Decoder module could perform additional functions in addition to those identified above. Furthermore, in the interests of better explaining the details of the Packet Decoder module, many conventional implementation-specific details well-known to those skilled in the art have been omitted, but could be incorporated in embodiments of the present invention.

In addition, as explained earlier, it is expected that different embodiments of the invention will utilize different types of packet formats from those depicted herein. For the most part, the specific formats of such packets is not material, and the present teachings are intended to extend to any packet formats that are compatible with processing techniques which permit a client—server data communications session to be re-started seamlessly in the event of a data disruption; i.e, without re-starting the transmission from scratch, or without re-sending each packet over again.

Furthermore, the packets may include additional information that is not specified here to accommodate a particular system, and such variations are clearly contemplated within the teachings of the present invention.

Finally, while the functions and features described above for the Packet Decoder module are unique to the present invention, it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

State information module 340 on the device (FIG. 3) is used to gather current resource information on the device as discussed in detail above. The resource data preferably includes the free memory on the device, the available battery life, the type of display unit on the device, the type of processor for the device, the pointing and peripheral devices that are attached to the mobile device, etc. etc.. Other types of resource information could be collected as well, including system “loading” for example, and similar technical details. This information is preferably passed to the server during the initial handshake, but can be sent at other times as well.

This information is preferably used on the server side to make decisions on the following issues and others alluded to before:

Software that is available for download to the device

The size of the packets for the data transfer

The power of the processor and the battery life will determine the level of encryption to be used

The state information is saved in the database for reports on the asset management for the vendors or the administrators of the system

It be apparent to skilled artisans that the aforementioned State Information module could perform additional functions in addition to those identified above. In addition, many conventional implementation-specific details well-known to those skilled in the art have been omitted, but could be incorporated in embodiments of the present invention.

Finally, the functions and features described above for the State Information module are unique to the present invention, but it is expected that the software routines for embodying the same can be implemented by those skilled in the art in accordance with the present teachings using a variety of conventional programming techniques for any particular environment. Thus, the present invention is by no means limited to any particular hardware/software implementation used to effectuate the functionality of such module as described herein.

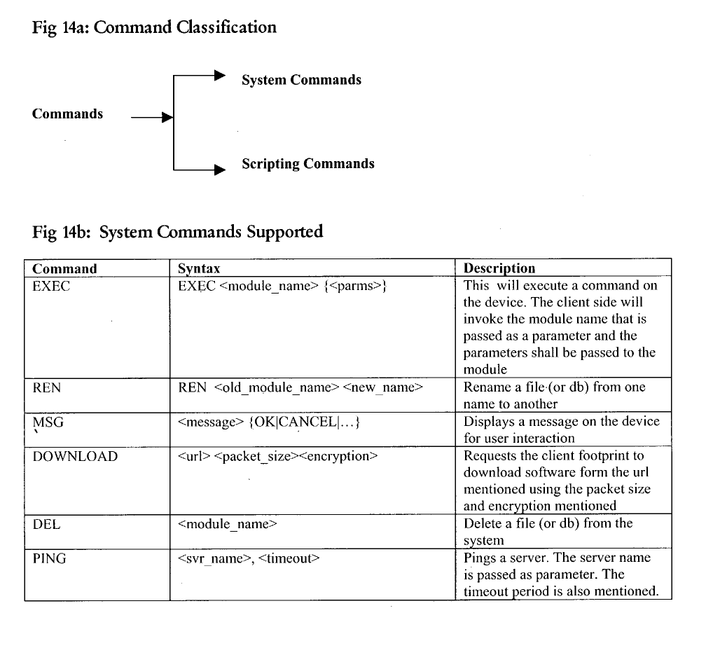

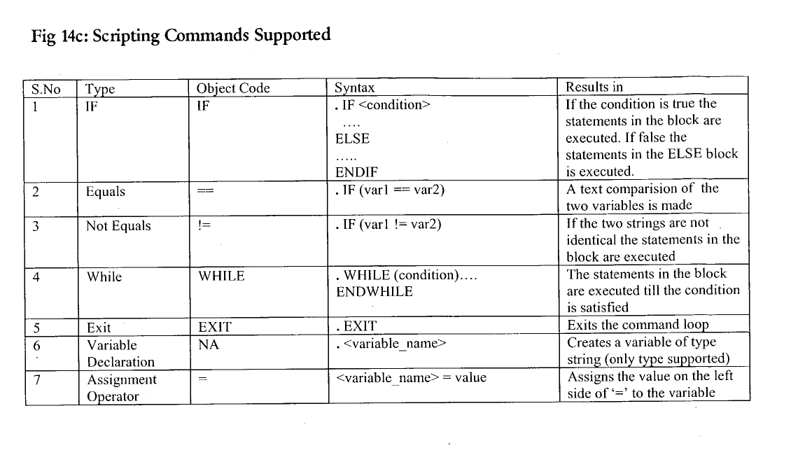

Command Execution Module 370 is responsible for system command execution on the client device. FIG. 14 shows some of the commands, and their syntax and descriptions. A command list can contain one or several of these commands. These commands may be needed to complete an action following a data transfer or may be required to initiate a data transfer operation. The command list is parsed and executed.

FIG. 14a shows two basic types of commands preferably used in embodiments of the present invention, namely, System commands and scripting commands. FIG. 14b shows the syntax of the system commands and the associated syntax. FIG. 14c shows some scripting commands that can be supported.

Those skilled in the art will appreciate that other types of commands can also be included within the functionality of Command Execution module 370, and the present invention is not limited in this respect. Furthermore, the software/firmware required to implement this module, and the other modules on the device side, can be implemented using a variety of well-known techniques based on the present teachings and with ordinary design skill.

Data Handler and Repository module 380 is responsible for the following functions.

Saving the data into a relational persistent database (not shown)

Retrieving the data from the database

Performing transformation on the meta-data depending on the type of device that makes the data request

The data is stored in the native format of the mobile devices, and thus will vary from system to system.

Device Response to Alarms and Installs

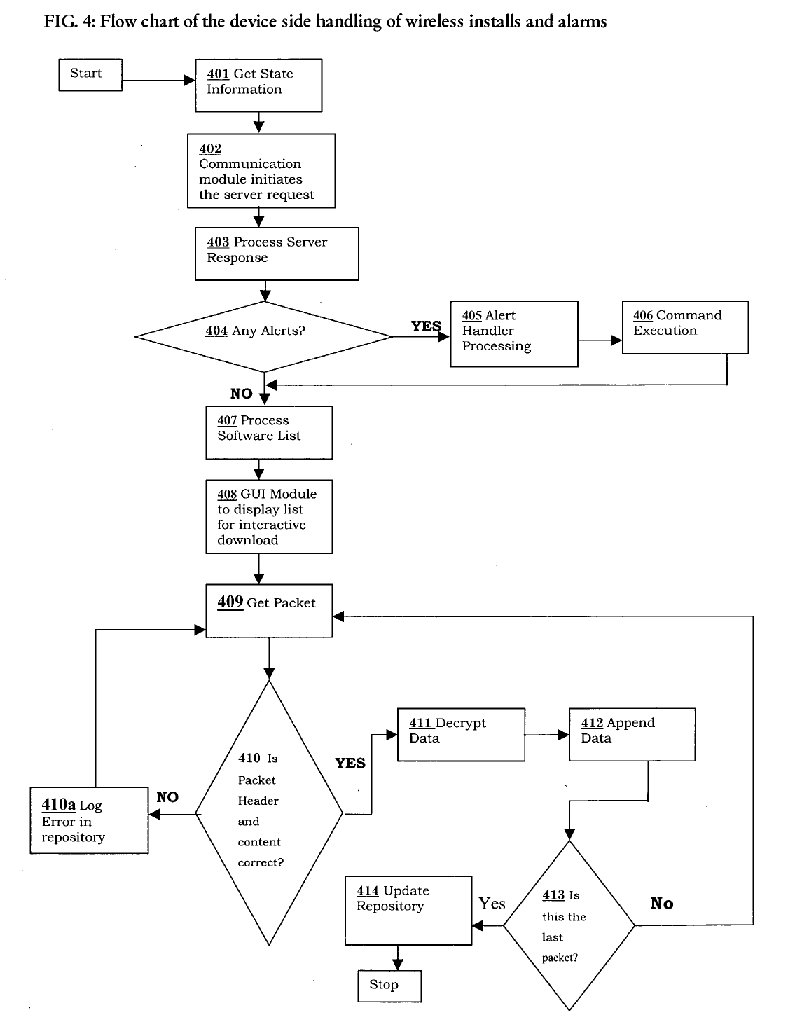

FIG. 4 shows the general steps performed by a client device of the present invention in response to various wireless installs and alarms. For the most part these have already been discussed in various places above, but they are consolidated here for ease of reference.

Step 401, Step 402 State information for the device is gathered, and a request for data is made to the server using Communication module 310 on the device using a standard HTTP protocol (or some other conventional protocol appropriate for the link in question).

Step 403 The server response for the data request is parsed to determine the type of actions that need to be performed on the device.

Step 404, 405, 406 The device checks to see if the response from the server contains any alarms; if so, Alarm Handler 350 and Command Execution module 370 are invoked.

Step 407 The server response can also contain a list of software that can be installed on the device. At this stage, the list is processed. The list contains information on the name of the application, the vendor who supplied the application, the cost of downloading the application, and the total size of the application. This information is displayed to the user in step 408.

Step 408 GUI Handler 330 is invoked to display the processed list obtained from step 407. The GUI Handler 330 displays this information by rendering the appropriate screens. If the user wishes to proceed with the download, step 409 is invoked.

Step 409 Communication module 310 is invoked to fetch the data packets from server 109.

Step 410, 411, 412, 413 This summarizes operations performed by Packet Decoder 360 and already described in detail above. The packets are examined to see if the size of the packet matches the expected size. If so the data is appended to the already downloaded data. If this is the last packet, the data download is complete and the rest of the installation steps can proceed since the data has been downloaded. If packets are encrypted using special encryption utilities, the appropriate decryption modules need to be invoked on the device.

Step 414 The repository on the device is updated with the information on the data that has been last downloaded.

Again, it will be understood by those skilled in the art that additional steps could also be performed in embodiments of the present invention.

Although the present invention has been described in terms of a preferred embodiment, it will be apparent to those skilled in the art that many alterations and modifications may be made to such embodiments without departing from the teachings of the present invention. Other types of components beyond those illustrated in the foregoing detailed description can be used suitably with the present invention. Similarly, descriptions of many common components usable with the inventions and known to skilled artisans have been omitted so as to not obfuscate the present teachings. Accordingly, it is intended that the all such alterations, modifications and additions be included within the scope and spirit of the invention as defined by the following claims.

Finally, it should be noted that the Title and Abstract of the present disclosure have been provided solely to satisfy certain U.S. governmental administrative requirements, including the indexing requirements of 37 C.F.R. 1.72, and for no other purpose. As such, such portions of the present disclosure should not be relied upon for interpreting and/or limiting the scope of the present claims.

What is claimed is:

1. A method of downloading data from a first computing device over a wireless channel to a second computing device, the method comprising the steps of:
a) initializing a data session over the wireless channel between the first computing device and the second computing device; and
b) evaluating transmission characteristics of the wireless channel for said data session, including an available bandwidth for data transmissions; and
c) determining a packet size to be used for data packets transferring data to the second computing device during said data session; and
d) notifying the second computing device of a number of packets (N) to be sent to the second computing device; and
e) counting said data packets when they are successfully received at the second computing device during said data session;
f) generating a completion signal when all of said number of packets a are received during said data session; and
g) re-initializing said data session to start a second data session if said data session is interrupted before said number of packets (N) are received at the second computing device;
h) wherein during said second data session only packets that were not originally successfully received are transferred from the first computing device to the second computing device.

2. The method of claim 1, wherein during step (c) an optimal packet size is determined for the second computing device by considering computing resources, memory resources and/or power resources available to the second computing device.

3. The method of claim 1, further including a step: providing a packet number within a header of each data packet sent to the second computing device.

4. The method of claim 1, further including a step: decrypting data contents of said data packets.

5. The method of claim 1, further including a step: assembling an application file to be stored on the computing device based on said data packets.

6. A method of installing a software application from a server to a wireless client device through a channel, the method comprising the steps of:
a) initializing a data link over the channel between the wireless client device and the server;
b) evaluating transmission bandwidth of said data link;
c) identifying characteristics of the wireless client device, including computing, memory and power resources available to such device;
d) determining an optimal packet size for transferring data to such device based on steps (b) and (c);
e) transferring the software application over the data link using said optimal packet size to the wireless client device so that the software application can be installed on such device.

7. The method of claim 6, further including a step of: sending a list of available applications that can be installed on the wireless client device.

8. The method of claim 7, further including a step of: determining said list of available applications by identifying a capacity of the wireless client device and determining whether what software applications have already been installed at the wireless client device.

9. The method of claim 6, further including a step of: encrypting data for the software application before step (e).

10. The method of claim 6, wherein the software application consists of N separate optimally sized packets, and if an interruption occurs during step (e) after K packets have been sent (where K<N), said transferring step (e) is re-initiated at a later time at which point a remaining number of packets (N-K) are transferred.

11. A method of providing an alert message to a user of a wireless client device through a channel, the method comprising the steps of:
a) receiving an alert message at a server, said alert message including any or all of the following: (1) a message for a user of the wireless client device; (2) a command to be executed by the wireless client device; (3) data to be used by the wireless device while executing said command; wherein said alert message is associated with a particular type of wireless client device and/or a particular type of user of a particular wireless client device;
b) processing said alert message at said server for propagation to one or more of said particular type of wireless client devices, said processing including formatting said alert message so that it can be displayed and/or executed if necessary on said particular type of wireless client device; and
c) transmitting said alert message to said particular type of wireless client device in response to a request for a data transmission through the channel from such particular type of wireless client device.

12. The method of claim 11, wherein said alert message includes a priority value, such that users of said particular type of wireless client device can control whether or not to receive such alert messages by specifying a threshold value which said priority value must exceed.

13. The method of claim 11, wherein said alert message is only sent to said particular type of user if a subscription option has been selected by said particular type of user.

14. The method of claim 11, wherein said alert message is generated by a vendor of a software application executing on the particular wireless client device.

15. The method of claim 14, wherein said alert message refers to a software update, and/or a virus alert.

16. A method of uploading a software application to a server for distribution to a wireless client device, the method comprising the steps of:
a) processing the software application to generate a device-specific version of the software application, said device-specific version of the software application being customized for a particular mobile client device;
b) initiating an upload session over the Internet between a first computer storing the device-specific version of software application and the server using a web-based interface;
c) transmitting device identification information from said first computer to the server to identify a class of mobile client devices suitable for receiving the device specific version of the software application;
d) transmitting device state information from said first computer to the server to identify computing resources and/or memory resources required by said class of mobile client devices to implement said device specific version of the software application.

17. The method of claim 16, further including a step of: transmitting encryption selection information to the server, which encryption selection information identifies an encryption module to be used with said device-specific version of the software application.

18. The method of claim 17, wherein said device state information further includes information identifying display settings to be used on said class of mobile client devices.

19. The method of claim 16, wherein a secure file transfer protocol session is set up between the first computer and the server when said first computer has a preferred subscriber relationship with the server.

20. The method of claim 16, further including a step: verifying that said device-specific version of the software is authentic at the server before distributing such software to any mobile client device.

21. A mobile computing device configured for executing a software application installation routine comprising:
a first communication software module adapted for receiving data packets over a wireless channel to a remote server; and
a second software application listing module for identifying a software application available for download from said remote server and for making a request to said remote server for said software application; and
a third packet handling software module adapted for:
a) configuring computing and memory resources of the mobile computing device to accommodate data packets associated with said software application; and
b) processing said data packets associated with said software application as they are received over the wireless channel; and
c) determining if all data packets associated with said software application have been received; and
d) installing the software application on the mobile computing device when all of said data packets for said software application are received.

22. The mobile computing device of claim 21, wherein said third packet handling software is further adapted to re-initialize communications with said remote server if an interruption occurs before all of said data packets associated with said software application are received.

23. The mobile computing device of claim 22, wherein said third packet handling software module maintains a count for said data packets associated with said software application, and reads a packet number contained in a header for each of such data packets during step (c).

24. The mobile computing device of claim 21, further including a decryption software module for decrypting data packets after they are received.

25. The mobile computing device of claim 21, further including an alarm software module for processing an alarm message sent to the mobile computing device, and for effectuating any control operations contained in said alarm message using at least some control data embedded in said alarm message.

26. The mobile computing device of claim 21, further including a device state software module for determining resource information for the mobile computing device, including at least an operating system used by the mobile computing device, available computing resources, available memory resources, and available power resources, which resource information is communicated to said remote server.

27. The mobile computing device of claim 26, wherein said device state software module further determines I/O resources, including display and user input capability available on mobile computing device, and any peripheral devices connected to the mobile computing device.

28. The mobile computing device of claim 27, wherein said device state software module further determines a bandwidth used during a prior data session with said remote server, and any other application software installed on the mobile computing device.

29. The mobile computing device of claim 21, further including a command execution software module for carrying out commands native to the mobile computing device, including execution of one or more of said first communication software module, said second software application listing module, and/or said third packet handling software module.

30. The mobile computing device of claim 21, further including a data handling module for converting received data in said data packets into a native format for the mobile computing device, and for saving said received data in a database for application software available for execution on the mobile computing device.

31. The mobile computing device of claim 21, further including a graphical user interface (GUI) module for presenting commands, options, and messages to a display of the mobile computing device.

32. The mobile computing device of claim 26, wherein said data packets use a packet size that is determined based on said resource information.

33. The mobile computing device of claim 21 wherein said mobile computing device includes:
a) processing means for executing said first communication software module, said second software application listing module, said third packet handling software module;
b) a wireless transceiver for communicating over said wireless channel under control of said first communication software module;
c) memory means for storing said data packets in cooperation with said processing means and said third packet handling software module;
d) a user interface for displaying said a list of software applications available for download from said remote server under control of said second software application listing module;
e) input means for receiving input data from a user concerning a selection for said list of software applications;
f) an operating system, which operating system coordinates said first communication software module, said second software application listing module, said third packet handling software module, as well as other operations involving said input means, said user interface, said processing means, said wireless transceiver and said memory means to effectuate said software application installation routine.

34. A packet processing system for communicating data from a first computing device to a second computing device over a wireless channel comprising:
a) a communications transceiver for transmitting and receiving data packets associated with a data session over the wireless channel; and
b) a data session initialization routine executing on the packet processing system, said data session initialization routine being adapted for setting up a data link over the wireless channel to communicate a data file between the first computing device and the second computing device; and
c) wherein said data session initialization routine receives device resource information concerning the second computing device;
d) further wherein said data session initialization routine determines an approximate bandwidth available for said data session over the wireless channel; and
e) a packet transfer routine for formatting said data file into a sequence of N separate data packets, said packet transfer routine using a packet size based on said device resource information and said approximate bandwidth.

35. The packet processing system of claim 34, wherein each of said packets have a format that includes: (1) a packet header; (2) a packet data field; (3) at least one packet data boundary field identifying a start and/or end of data in said packet data field.

36. The packet processing system of claim 35, wherein said packet header includes: (a) a packet id; (b) a packet number; (c) a data file ID associated with said data file.

37. The packet processing system of claim 36, wherein at least one of said packet headers further includes (d) a total number of packets for said data session; (e) a type of encryption used for said data session; (f) a packet type for said packet.

38. The packet processing system of claim 34, wherein said approximate bandwidth is determined by a time measurement generated from setting a timer on the second computing device and measuring a time required for receiving a first reference file from the first computing device.

39. The packet processing system of claim 38, wherein said time measurement is repeated at least one more time for a second reference file.

40. The packet processing system of claim 38, wherein a second timer is used on the first computing device to determine a latency of such first computing device compared to a latency of the wireless channel.

41. A computing system configured as a wireless internet server and comprising:
a) a communications routine for transmitting and receiving data packets associated with a data session with a client computing device over the wireless channel; and
b) a data session initialization routine for setting up a data ink over the wireless channel to transfer a data file to said client computing device; and
c) a device recognition routine for identifying a device ID associated with said client computing device; and
d) wherein said device ID is used by the computing system with a lookup table to determine appropriate transmission parameters to be used for said data session based on device characteristics for said client computing device;
e) a packet transfer routine for formatting said data file into a sequence of data packets for transmission by said communications routine, said packet transfer routine using said appropriate transmission parameters to determine a nominal packet format to be used for said data session; and
f) wherein said data file includes one of the following: (1) a software application executable on said client computing device; and/or (2) an alarm message intended for a user of the client computing device.

42. The computing system of claim 41, wherein said packet transfer routine further uses a measurement of an approximate bandwidth available for said data sessions to determine said packet format, including a data packet size.

43. The computing system of claim 41, further including an update routine for tracking downloads made to said client-computing device.

44. The computing system of claim 41, wherein said device characteristics are stored in a database on the computing system and include: (1) a device type; (2) computing resources available with said client computing device; (3) memory resources available with said client computing device.

45. The computing system of claim 44, wherein said database further includes device characteristics including: battery resources for said client computing device.

46. The computing system of claim 44, wherein said database further includes device characteristics including: prior bandwidth used by downloads by said client computing device.

47. The computing system of claim 44, wherein said database further includes device characteristics including: prior software applications and/or alarms propagaged to said client computing device.

48. The computing system of claim 44, further including an interface module for receiving software applicants and/or alarm messages from a remote server for distribution to said client computing device.

49. The computing system of claim 44, further including an accounting module for providing a report concerning a number of downloads made by the computing system of a particular software application.

50. The computing system of claim 49 wherein said accounting module provides a report on an identity of providers of said data files.

51. The computing system of claim 50 wherein said accounting module provides a report on users who have made a download of a specific software application.

52. The computing system of claim 44 further including a fault recovery module for creating companion computing systems to service said data session in the event of failure of the computing system.

53. A system for distributing data over a wireless channel comprising:
a) a client device for initiating a data session and providing a request for a data file; and
b) a server device for responding to said request for said data file, and setting up a data link over the wireless channel to said client device; and
c) a packet transmission system coupled to said server device, for formatting said data file into data packets, said data packets having a format derived from analyzing device characteristics of said client device and transmission characteristics of the wireless channel; and
d) a packet receive system coupled to said client device for unpacking said data packets into a format suitable for use on said client device, said packet receive system being further configured for re-initiating a separate data session in the event said data file is not completely received.

54. The system of claim 54, wherein said packet receive system causes only data packets that were not received during said data session to be transferred during said separate data session.

55. The system of claim 54, wherein said device characteristics include a processor, a memory, and a power source associated with said client device.

56. The system of claim 54, wherein said data file includes both software applications and/or an alarm message for said client device.

57. The system of claim 54, wherein said client device includes a routine for identifying software applications available for download from said server device.

58. The system of claim 54, wherein said server device stores device specific information for each client device that can access said server device, including device IDs and prior downloads made to such devices.

59. The system of claim 54, further including an interface routine for receiving uploads of software applications and alarm messages.

60. The system of claim 54, wherein an available bandwidth in the data channel is determined prior to said data session.
